(19) United States
(12) Patent Application Publication
(10) Pub. No.: US 2002/0161848 A1
(43) Pub. Date: Oct. 31, 2002

(54) Systems and methods for facilitating memory access in information management environments

(76) Inventors: Charles A. Willman, Austin, TX (US); Matthew E. Curley, Tomball, TX (US); Roger K. Richter, Leander, TX (US); Peter G. Dunlap, Austin, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/125,065

(22) Filed: Apr. 18, 2002

Related U.S. Application Data
(63) Continuation-in-part of application No. 09/879,810, filed on Jun. 12, 2001.
(63) Continuation-in-part of application No. 09/797,200, filed on Mar. 1, 2001.
(63) Continuation-in-part of application No. 09/797,197, filed on Mar. 1, 2001.
(60) Provisional application No. 60/358,244, filed on Feb. 20, 2002.
(60) Provisional application No. 60/285,211, filed on Apr. 20, 2001.
(60) Provisional application No. 60/291,073, filed on May 15, 2001.
(60) Provisional application No. 60/246,401, filed on Nov. 7, 2000.
(60) Provisional application No. 60/187,211, filed on Mar. 3, 2000.
(60) Provisional application No. 60/246,443, filed on Nov. 7, 2000.

(51) Int. Cl. G06F 15/173; G06F 15/16

(52) U.S. Cl. 709/213; 709/230

(57) ABSTRACT

Systems and methods that may be employed to facilitate communication between separate processing objects interconnected by a distributed interconnect. For example, remote access to the operating system or file system memory of a first processing object may be effectively provided to a second processing object by using a tag or identifier to label individual data packets exchanged between the two processing objects.

This application claims priority to co-pending provisional application serial No. 60/358,244 filed on Feb. 20, 2002 which is entitled “SYSTEMS AND METHODS FOR FACILITATING MEMORY ACCESS IN INFORMATION MANAGEMENT ENVIRONMENTS,” the disclosure of which is incorporated herein by reference. This application is also a continuation-in-part of co-pending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” which itself claims priority from co-pending U.S. provisional application serial No. 60/285,211 filed on Apr. 20, 2001 which is entitled “SYSTEMS AND METHODS FOR PROVIDING DIFFERENTIATED SERVICE IN A NETWORK ENVIRONMENT,” and which also claims priority from co-pending U.S. provisional application serial No. 60/291,073 filed on May 15, 2001 which is entitled “SYSTEMS AND METHODS FOR PROVIDING DIFFERENTIATED SERVICE IN A NETWORK ENVIRONMENT,” and which also claims priority from U.S. provisional application serial No. 60/246,401 filed on Nov. 7, 2000 which is entitled “SYSTEM AND METHOD FOR THE DETERMINISTIC DELIVERY OF DATA AND SERVICES,” and which also is a continuation-in-part of co-pending U.S. patent application Ser. No. 09/797,200 filed on Mar. 1, 2001 which is entitled “SYSTEMS AND METHODS FOR THE DETERMINISTIC MANAGEMENT OF INFORMATION” which itself claims priority from U.S. patent application serial No. 60/187,211 filed on Mar. 3, 2000 which is entitled “SYSTEM AND APPARATUS FOR INCREASING FILE SERVER BANDWIDTH,” the disclosures of each being incorporated herein by reference. This application is also a continuation-in-part of U.S. patent application Ser. No. 09/797,197 filed on Mar. 1, 2001, which is entitled “METHODS AND SYSTEMS FOR THE ORDER SERIALIZATION OF INFORMATION IN A NETWORK PROCESSING ENVIRONMENT,” which itself claims priority from U.S. provisional application serial No. 60/246,443 filed on Nov. 7, 2000, which is entitled “METHODS AND SYSTEMS FOR THE ORDER SERIALIZATION OF INFORMATION IN A NETWORK PROCESSING ENVIRONMENT,” the disclosures of each of which are incorporated herein by reference.

### BACKGROUND OF THE INVENTION

The present invention relates generally to computing systems, and more particularly to network connected computing systems.

A wide variety of computing systems may be connected to computer networks. These systems may include network endpoint systems and network intermediate node systems. Servers and clients are typical examples of network endpoint systems and network switches are typical examples of network intermediate node computing systems. Many other types of network endpoint systems and network intermediate node systems also exist.

Most network computing systems, including servers and switches, are typically provided with a number of subsystems that interact to accomplish the designated task/s of the individual computing system. Each subsystem within such a network computing system is typically provided with a number of resources that it utilizes to carry out its function. In operation, one or more of these resources may become a bottleneck as load on the computing system increases, ultimately resulting in degradation of client connection quality, severance of one or more client connections, and/or server crashes.

As the desire for increased network bandwidth, speed and general performance is always present, many different techniques have been utilized to achieve such goals. Network computing system bottlenecks have traditionally been dealt with by throwing more resources at the problem. For example, when performance degradation is encountered, more memory, a faster CPU (central processing unit), multiple CPU's, or more disk drives are added to the server in an attempt to alleviate the bottlenecks. Such solutions therefore typically involve spending more money to add more hardware. Besides being expensive and time consuming, the addition of hardware often only serves to push the bottleneck to a different subsystem or resource.

In a server environment a compute/performance bottleneck is often dealt with by merely adding more servers which operate in parallel. Thus a “rack and stack” or “server farm” solution to a network performance problem has developed. Merely adding more servers to solve a bottleneck is often wasteful of resources as the bottleneck may be related to just one particular type of resource, yet the addition of a complete server, or sets of servers, provides many types of additional resources. For example, a bottleneck may relate to application processor resources yet the addition of more servers also provides additional memory resources, network interface resources, etc., all of which may not be required, or under utilized.

Alternatively, more elegant attempts to improve network computing performance have been made. However, these more elegant solutions generally employ proprietary operating systems which have been optimized for specific tasks thereby making these more elegant solutions expensive and significantly limited by their underlying system architecture. Furthermore, when a wide variety of techniques and operating systems are utilized, the users implementation and maintenance of such systems becomes a harder task. Also the limited flexibility and versatility of such equipment makes it a very restrictive investment.

### SUMMARY OF THE INVENTION

Disclosed herein are systems and methods that may be employed to facilitate communication between two or more separate processing objects in communication with each other, and in one embodiment to advantageously provide remote memory access capability between two or more separate processing objects in communication in a distributed processing environment having distributed memory, e.g., such as two or more separate processing objects in communication across a distributed interconnect such as a switch fabric. Specific examples of processing objects with which the disclosed systems and methods may be practiced include, but are not limited to operating system objects (e.g., application operating system objects, storage operating system objects, etc.), file system objects, buffer/cache objects, logical volume management objects, etc. The disclosed systems and methods may be practiced to provide remote memory access between two or more communicating processing objects that are resident on the same processing engine or module, or alternatively that are resident on separate processing engines or modules.

The disclosed systems and methods may be implemented in one embodiment to provide one or more processing objects with transactional-based memory access to the memory of one or more other processing objects, and/or vice-versa. In this embodiment, such memory access may be further provided without the need for memory to memory copies, (such copies tend to increase resource consumption including memory and CPU cycles, and therefore serve to reduce system performance). Advantageously, such transactional-based memory access may be provided, for example, without requiring specialized hardware support, without requiring pre-programming of memory locations or setting up (or “mapping”) of memory regions ahead of time, and without requiring negotiation of an end-to-end static or logical communication channel between processing objects. Such transactional-based memory access may also be provided without requiring expensive setup of target and sources (e.g., without requiring dedicated messaging for setup, and without need for “out-of-band” negotiation of memory spaces that occur outside a data transaction on each end before a data transaction is performed). This capability is advantageous because such setup generally consumes processing resources itself, requires additional specialized hardware and software to implement, and requires consumption of memory and device resources on both target and source ends. Further advantageously, transactional-based memory access of the disclosed systems and methods may be implemented in a manner that allows mixing of memory capabilities (e.g., mixing of 32-bit and 64-bit memory compatibilities), and/or on a selective or selectable ad hoc basis (e.g., implemented only for selected I/O operations that occur between separate devices).

In one embodiment, transactional-based memory access may be characterized as a message-based memory access in which messages including memory location information may be exchanged synchronously (e.g., in conjunction with specific requests for data, etc.) and/or asynchronously (e.g., in stand-alone manner independent of specific requests for information or other messaging between processing objects) between two or more processing objects that may be resident on one or more processing engines of an information management system, such as a content delivery system. In one example of asynchronous exchange, memory location information including one or more memory addresses of a first processing object may be supplied in an independent message communicated to a second processing object for use by the second processing object for future access/es (e.g., modification/s) of these memory addresses, for example, when responding to future request/s for data by the first processing object or when forwarding events destined for the first processing object from a third processing object. Such memory location information may be communicated to the second processing object by the first processing object, and/or by one or more other processing objects (e.g., independent or intermediary processing objects).

In one exemplary embodiment, data delivery to an operating system or file system object of a first processing engine via an I/O device system object of a second processing engine (e.g., storage processing engine delivery of data to an application processing engine, specifically the file system, etc.) may be facilitated. For example, remote access to the operating system or file system memory of a first processing engine may be effectively provided to a second processing engine, for example, by using a tag or identifier to label individual data packets exchanged between the two processing engines across a distributed interconnect.

When implemented in conjunction with an application operating system and a storage operating system communicating across a distributed interconnect, the need for buffer copies in the read I/O path between the two operating systems (e.g., copies that traditionally occur when an application operating system initiates a “read I/O” of file data from storage operating system) may be eliminated, thus reducing processor cycle consumption that would otherwise be required for purposes of creating and processing such buffer copies. This feature may be advantageously employed to free a substantial portion of application operating system processor capacity by reducing the number of CPU cycles spent performing memory-to-memory copies and thus decreasing CPU utilization in the application operating system so that it may be used for other purposes. This feature may be further employed to eliminate “order of arrival” issues that are often encountered in certain types of data transfers (e.g., storage), enabling a greater degree of parallelism in the processing of I/O requests. Further benefits that may be realized include the reduction or elimination of the need for serialization of requested portions of data or other information retrieved, for example, partly from cache and partly from disk storage.

The disclosed systems and methods may also be advantageously implemented to enable remote memory access between two or more communicating processing objects and/or processing entities (e.g., processing engines or modules) having disparate memory spaces and/or operating environments on a per-message basis and without need for hardware mapping assumptions. The disclosed distributed RMA message-passing architecture does not require mapping of memory regions onto media hardware, and advantageously allows distributed RMA tags to be embedded “on the fly” into any type of message that may be exchanged between separate processing entities and/or processing objects. Being message-based, with no hardware mapping assumptions, allows remote memory access to be provided using the disclosed systems and methods in a manner that allows any form of distributed communication, both synchronous and asynchronous, over various media types. Furthermore, the disclosed distributed RMA message-passing architecture may be implemented to provide remote memory access “in-band” or within a transaction, without the need for out-of-band or pre-transaction negotiation.

In one respect, disclosed herein is a distributed remote memory access (RMA) message passing architecture that may be employed to reduce memory-to-memory copying in a distributed interconnect-based message passing environment. In one embodiment, the disclosed architecture may include a fabric RMA engine and a fabric dispatcher implemented on each of at least two separate processing engines (e.g., application processing engine and storage processing engine) that communicate via message passing across a distributed interconnect using a distributed RMA protocol. Such a distributed RMA message passing architecture may be so implemented to allow storage messages to be transferred directly from a distributed interconnect into application operating system buffers without the need for intermediate buffer copies. Likewise, write messages to storage may be communicated from a distributed interconnect directly into storage operating system memory. In such an embodiment, the disclosed distributed RMA message passing architecture may be implemented so that it does not require storage operating system knowledge of application operating system memory architecture (or vice versa), so that it does not affect storage operating system optimizations, and/or so that it is compatible with multiple application streams (e.g., capable of transferring messages directly into the memory of a targeted operating system even though they are received out of order and/or are mixed with messages destined for other operating systems).

In one embodiment, the disclosed distributed RMA message passing architecture may be implemented in an ad hoc transaction-based manner so that it simultaneously supports both distributed RMA protocol messages and non-distributed RMA protocol messages, thus increasing system flexibility, capacity and capability. In this regard, distributed RMA protocol messages and non-distributed RMA protocol messages may be multiplexed and communicated from a source processing engine across a distributed interconnect, and then de-multiplexed upon arrival at a destination processing engine for individualized processing. Such an implementation may be used to implement differentiated services by selectively utilizing distributed RMA protocol messaging to process certain requests and using non-distributed RMA protocol messaging to process other requests. Furthermore, the disclosed distributed RMA message passing architecture may also be selectably implemented in a manner that is dependent on one more characteristics associated with a particular information request and/or information response, e.g., selectably implemented depending on selected packet type associated with the request and/or response.

In another embodiment, multiple message transmit and/or multiple message receive queues may be implemented on one or more processing engines interconnected by a distributed interconnect. Such queues may be employed, for example, to selectively prioritize certain data requests and/or responses to data requests over other such requests and/or responses on one or more processing engines, e.g., as part of a differentiated services implementation. Multiple message queues may also be employed to demultiplex distributed RMA protocol messages from non-distributed RMA protocol messages, for example, by designating at least one receive queue for handling distributed RMA protocol messages, and at least one other receive queue for handling non-distributed RMA protocol messages.

In yet another embodiment, distributed RMA protocol messages may be employed to communicate buffer list/s for placement of information from one processing object to another processing object (e.g., from application operating system to storage operating system, or vice-versa), e.g., to provide memory access in an asynchronous manner. In a further embodiment, flow control of information communicated between two or more processing objects may be optionally implemented by using distributed RMA protocol messages to communicate buffer list/s for placement of information from one processing object to another processing object (e.g., from application operating system to storage operating system, or vice-versa) in a manner that controls flow of the requested information. This may be implemented to control flow of information in one embodiment by virtue of the fact that a first processing object will only communicate information to a second processing object when it has access to identity of available memory locations for placement of the information into memory of the second processing object (e.g. via tags or identifiers sent synchronously or asynchronously by the second processing object specifying available memory location placement for that information). Thus, a second processing object may control flow of requested information from the first processing object, for example, by controlling access to the identity of available memory locations by the first processing object, e.g., by controlling the rate of synchronous or asynchronous transmission of distributed RMA tags or identifiers sent to the first processing object, etc.

In a further embodiment, controlled access to the memory of one or more first processing objects may be provided to one or more second processing objects by using virtual tags or identifiers that do not represent literally the memory address/es f the first processing object/s. For example, virtual tags may be implemented using translated address information, address keys, encoded or encrypted address information, etc. Controlled remote memory access may be advantageously used to provide the advantages of remote access to the memory of the first processing object/s, while at the same time providing memory address security (e.g., to prevent accidental or intentional damage or other undesirable access to the memory of the first processing object/s by other processing objects).

In one respect, disclosed herein a method of exchanging information between a first processing object and a second processing object. This method may include: labeling a first information with a first identifier; communicating the first information from the first processing object to the second processing object; labeling a second information with a second identifier, the second identifier being based at least in part on the first identifier; communicating the second information from the second processing object to the first processing object; and accessing a particular location in a memory associated with the first processing object based at least in part on the second identifier.

In another respect, disclosed herein is a method of exchanging information between first and second processing entities that are communicatively coupled together. This method may include: communicating a first information from a first processing entity to a second processing entity, the first information being labeled with a first identifier representing a particular location in the memory of the first processing entity; communicating a second information from the second processing entity to the first processing entity, the second information being labeled with a second identifier based at least in part on the first identifier with which the first information was labeled; and accessing a particular location in a memory associated with the first processing entity based at least in part on the second identifier.

In another respect, disclosed herein is a method of exchanging information between first and second processing engines of an information management system that includes a plurality of individual processing engines coupled together by a distributed interconnect. This method may include communicating distributed RMA protocol requests for information across the distributed interconnect from a first processing engine to a second processing engine, each of the distributed RMA protocol requests for information being labeled with a respective identifier representing a particular location in the memory of the first processing engine; responding to each of the distributed RMA protocol requests for information by communicating a respective distributed RMA protocol response to the distributed RMA protocol request for information across the distributed interconnect from the second processing engine to the first processing engine, each of the distributed RMA protocol responses including information requested by a respective distributed RMA protocol request for information and being labeled with the identifier with which the respective distributed RMA protocol request for information was labeled; and placing the requested information included with each respective distributed RMA protocol response into a particular location in the memory of the first processing engine represented by the identifier with which the respective distributed RMA protocol response was labeled.

In another respect, disclosed herein is a system for exchanging information between a first processing entity and a second processing entity. The system may include: a first processing entity configured to generate a first information, to label the first information with a first identifier, and to communicate the first information to the second processing entity; and a second processing entity configured to generate a second information, to label the second information with a second identifier based at least in part on the first identifier, and to communicate the second information to the first processing entity. The first processing entity may be further configured to access a particular location in a memory associated with the first processing entity based at least in part on the second identifier.

In another respect, disclosed herein is a system for exchanging information between first and second processing engines of an information management system that includes a plurality of individual processing engines coupled together by a distributed interconnect. The system may include a first processing engine configured to communicate first distributed RMA protocol messages across the distributed interconnect to a second processing engine, each of the distributed RMA protocol messages being labeled with one or more respective identifiers representing one or more particular locations in the memory of the first processing engine; and a second processing engine configured to communicate second distributed RMA protocol messages across the distributed interconnect to the first processing engine, the second distributed RMA protocol messages including information labeled with one or more identifiers with which at least one or the first distributed RMA protocol messages was labeled. The first processing engine may be further configured to place the information included with the second distributed RMA protocol messages into particular locations in the memory of the first processing engine represented by the one or more identifiers with which the second distributed RMA protocol messages are labeled.

In another respect, disclosed herein is a network connectable content delivery system. This system may include: an application processing engine, the application processing engine including an application operating system, an AOS fabric dispatcher, an application fabric RMA engine, and one or more AOS buffers; and a storage processing engine communicatively coupled to the application processing engine by a distributed interconnect, the storage processing engine including a storage operating system, a SOS fabric dispatcher and a storage fabric RMA engine. In this system, the application operating system may be in communication with the AOS fabric dispatcher, the AOS fabric dispatcher may be in communication with the application fabric RMA engine, and the application fabric RMA engine may be in communication with the distributed interconnect. Further, the storage operating system may be in communication with the SOS fabric dispatcher, the SOS fabric dispatcher may be in communication with the storage fabric RMA engine, and the storage fabric RMA engine may be in communication with the distributed interconnect.

### BRIEF DESCRIPTION OF THE DRAWINGS

FIG. 1A is a representation of components of a content delivery system according to one embodiment of the disclosed content delivery system.

FIG. 1B is a representation of data flow between modules of a content delivery system of FIG. 1A according to one embodiment of the disclosed content delivery system.

FIG. 1C is a simplified schematic diagram showing one possible network content delivery system hardware configuration.

FIG. 1D is a simplified schematic diagram showing a network content delivery engine configuration possible with the network content delivery system hardware configuration of FIG. 1C.

FIG. 1E is a simplified schematic diagram showing an alternate network content delivery engine configuration possible with the network content delivery system hardware configuration of FIG. 1C.

FIG. 1F is a simplified schematic diagram showing another alternate network content delivery engine configuration possible with the network content delivery system hardware configuration of FIG. 1C.

FIGS. 1G-1J illustrate exemplary clusters of network content delivery systems.

FIG. 2 is a simplified schematic diagram showing another possible network content delivery system configuration.

FIG. 2A is a simplified schematic diagram showing a network endpoint computing system.

FIG. 2B is a simplified schematic diagram showing a network endpoint computing system.

FIG. 3 is a functional block diagram of an exemplary network processor.

FIG. 4 is a functional block diagram of an exemplary interface between a switch fabric and a processor.

FIG. 5 is a representation of a distributed RMA protocol PDU header format according to one embodiment of the disclosed systems and methods.

FIG. 6A is a functional block diagram of an exemplary distributed remote memory access protocol according to one embodiment of the disclosed systems and methods.

FIG. 6B is a functional block diagram of an exemplary distributed remote memory access protocol according to one embodiment of the disclosed systems and methods.

FIG. 7 is a functional block diagram of an exemplary distributed remote memory access protocol according to one embodiment of the disclosed systems and methods.

### DESCRIPTION OF ILLUSTRATIVE EMBODIMENTS

Disclosed herein are systems and methods for operating network connected computing systems. The network connected computing systems disclosed provide a more efficient use of computing system resources and provide improved performance as compared to traditional network connected computing systems. Network connected computing systems may include network endpoint systems. The systems and methods disclosed herein may be particularly beneficial for use in network endpoint systems. Network endpoint systems may include a wide variety of computing devices, including but not limited to, classic general purpose servers, specialized servers, network appliances, storage area networks or other storage medium, content delivery systems, corporate data centers, application service providers, home or laptop computers, clients, any other device that operates as an endpoint network connection, etc.

Other network connected systems may be considered a network intermediate node system. Such systems are generally connected to some node of a network that may operate in some other fashion than an endpoint. Typical examples include network switches or network routers. Network intermediate node systems may also include any other devices coupled to intermediate nodes of a network.

Further, some devices may be considered both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

For ease of understanding, the systems and methods disclosed herein are described with regards to an illustrative network connected computing system. In the illustrative example the system is a network endpoint system optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands.

It will be recognized that the hardware and methods discussed below may be incorporated into other hardware or applied to other applications. For example with respect to hardware, the disclosed system and methods may be utilized in network switches. Such switches may be considered to be intelligent or smart switches with expanded functionality beyond a traditional switch. Referring to the content delivery application described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the present invention are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application, it will be recognized that many other tasks or applications performed with the hardware and methods.

Disclosed herein are systems and methods for delivery of content to computer-based networks that employ functional multi-processing using a “staged pipeline” content delivery environment to optimize bandwidth utilization and accelerate content delivery while allowing greater determination in the data traffic management. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources, I/O resources, etc.) to be deployed by sharing or reassignment in order to maximize acceleration of content delivery by the content delivery system. The use of a scalable packet-based interconnect, such as a switch fabric, advantageously allows the installation of additional subsystem modules without significant degradation of system performance. Furthermore, policy enhancement/enforcement may be optimized by placing intelligence in each individual modular processing engine.

The network systems disclosed herein may operate as network endpoint systems. Examples of network endpoints include, but are not limited to, servers, content delivery systems, storage systems, application service providers, database management systems, corporate data center servers, etc. A client system is also a network endpoint, and its resources may typically range from those of a general purpose computer to the simpler resources of a network appliance. The various processing units of the network endpoint system may be programmed to achieve the desired type of endpoint.

Some embodiments of the network endpoint systems disclosed herein are network endpoint content delivery systems. The network endpoint content delivery systems may be utilized in replacement of or in conjunction with traditional network servers. A “server” can be any device that delivers content, services, or both. For example, a content delivery server receives requests for content from remote browser clients via the network, accesses a file system to retrieve the requested content, and delivers the content to the client. As another example, an applications server may be programmed to execute applications software on behalf of a remote client, thereby creating data for use by the client. Various server appliances are being developed and often perform specialized tasks.

As will be described more fully below, the network endpoint system disclosed herein may include the use of network processors. Though network processors conventionally are designed and utilized at intermediate network nodes, the network endpoint system disclosed herein adapts this type of processor for endpoint use.

The network endpoint system disclosed may be construed as a switch based computing system. The system may further be characterized as an asymmetric multiprocessor system configured in a staged pipeline manner.

Exemplary System Overview

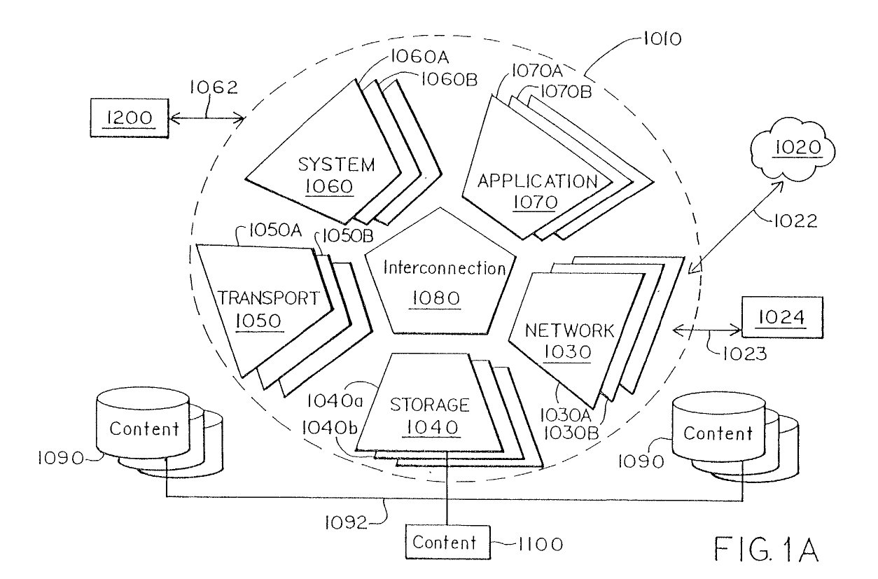

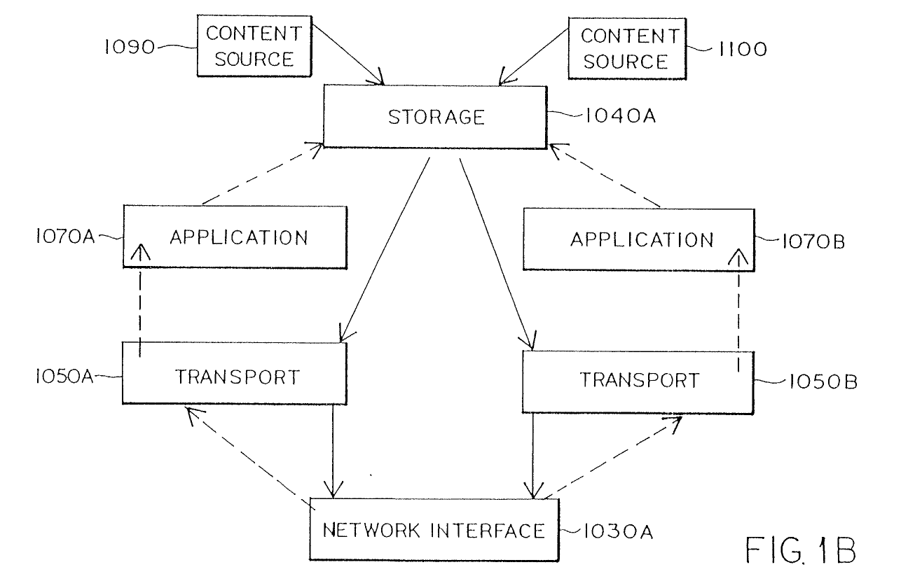

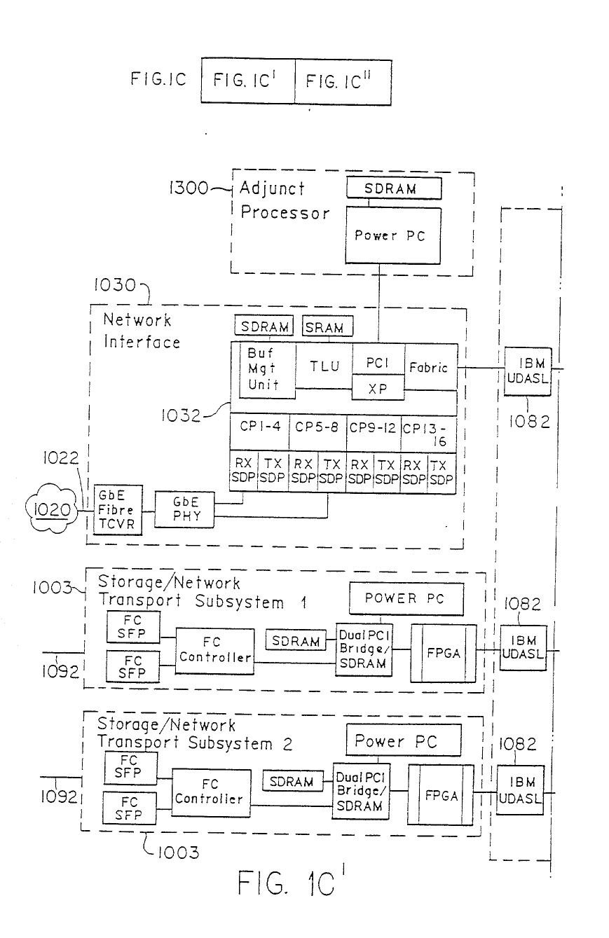

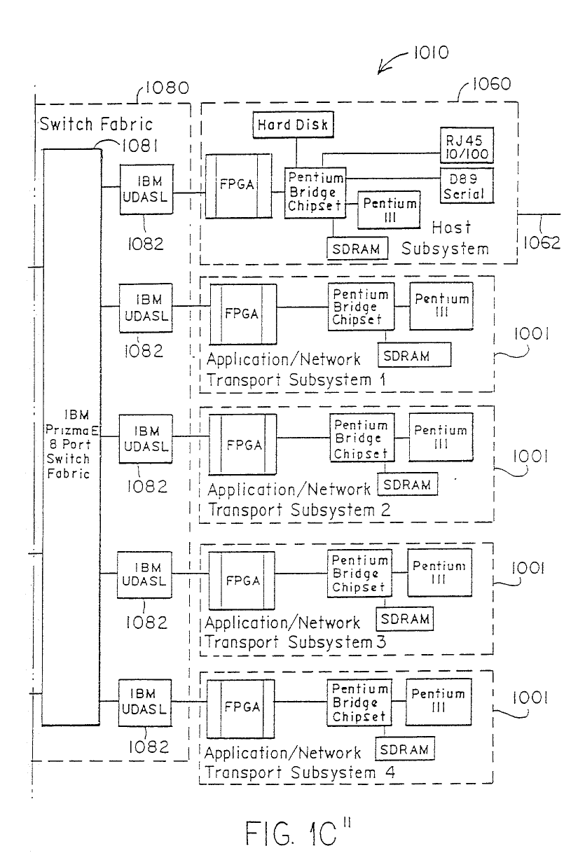

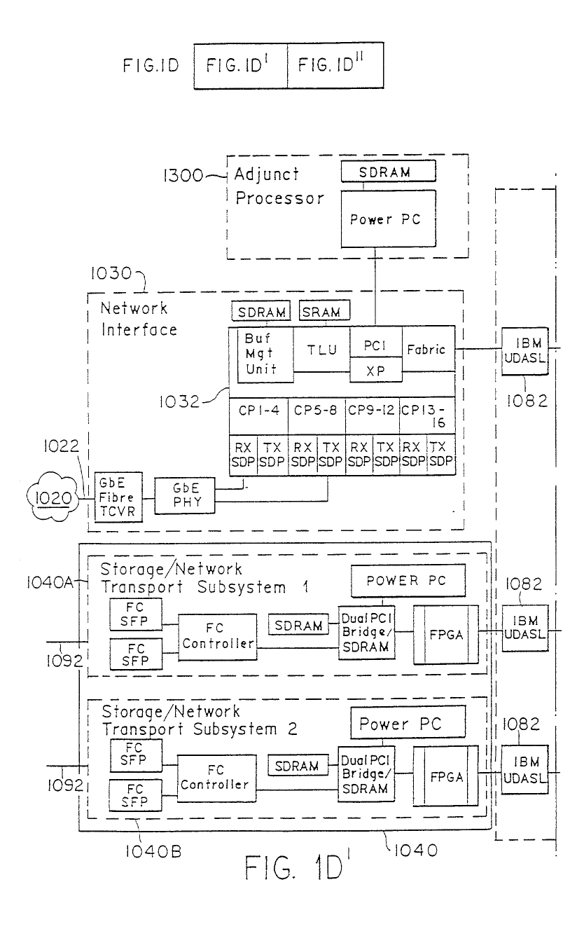

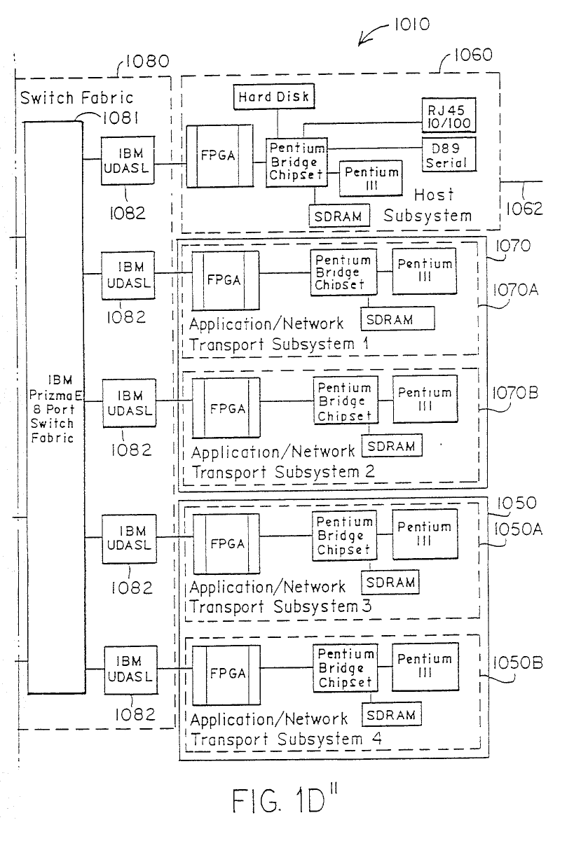

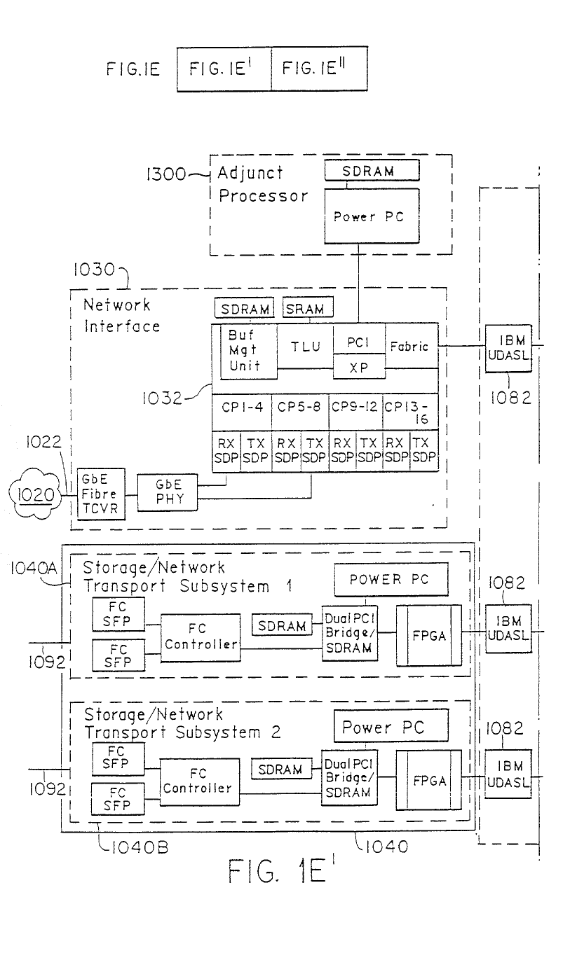

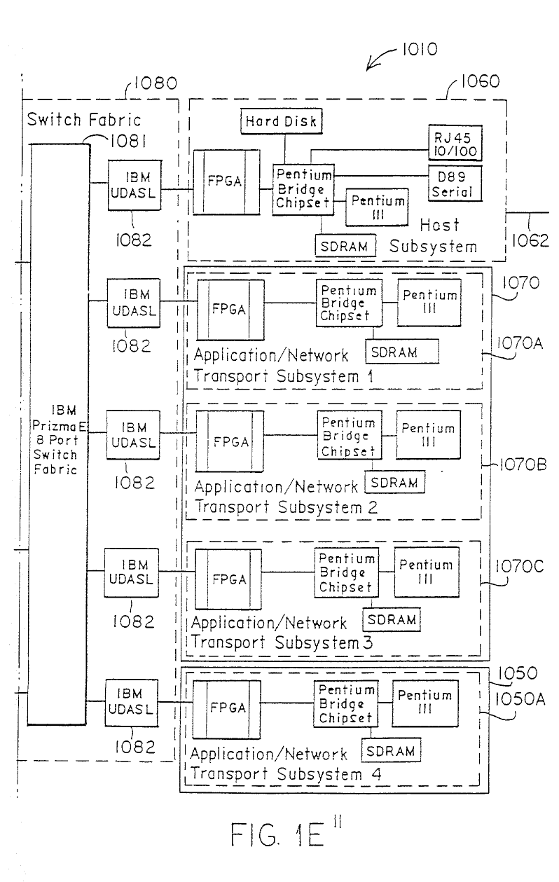

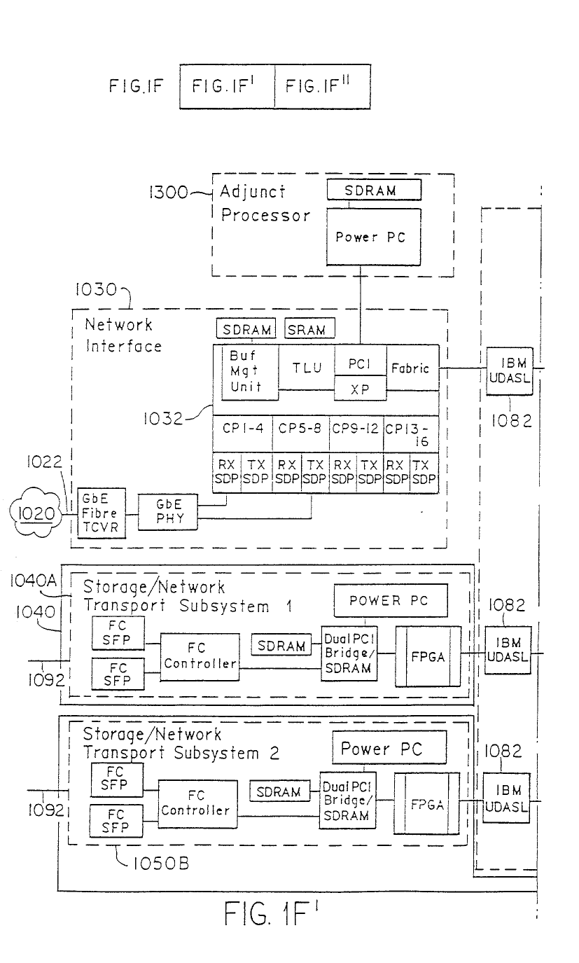

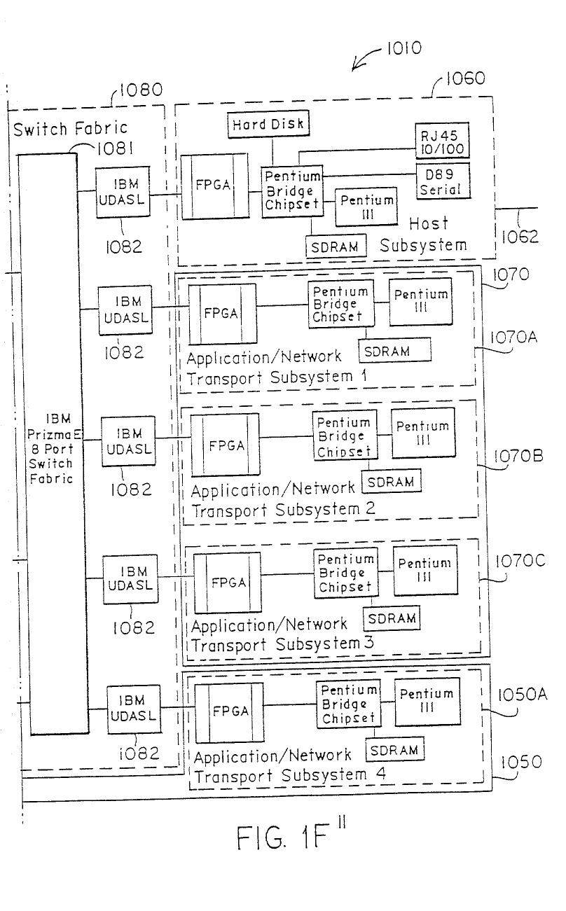

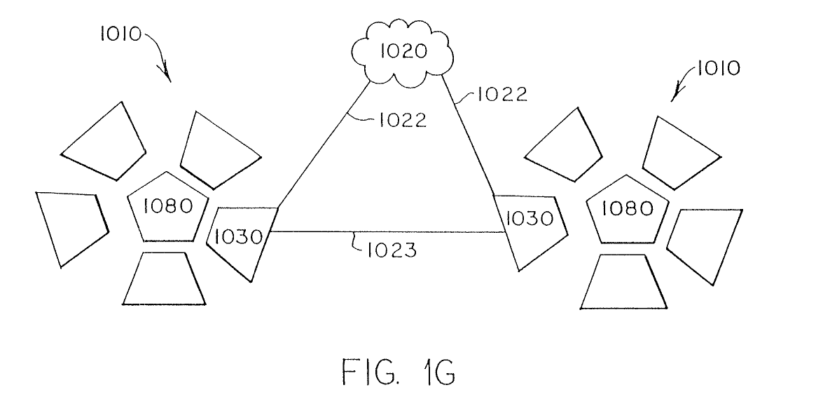

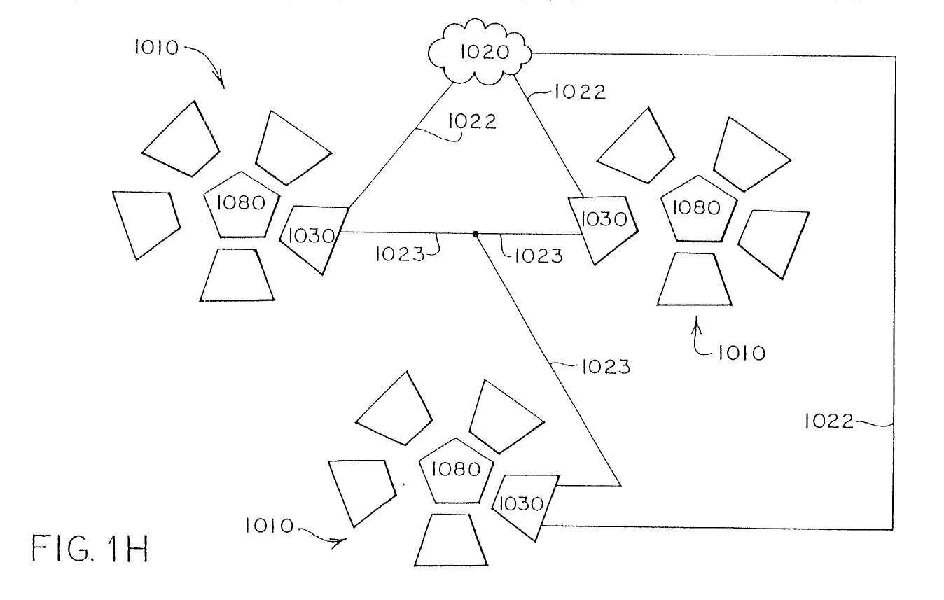

FIG. 1A is a representation of one embodiment of a content delivery system 1010, for example as may be employed as a network endpoint system in connection with a network 1020. Network 1020 may be any type of computer network suitable for linking computing systems. Content delivery system 1010 may be coupled to one or more networks including, but not limited to, the public internet, a private intranet network (e.g., linking users and hosts such as employees of a corporation or institution), a wide area network (WAN), a local area network (LAN), a wireless network, any other client based network or any other network environment of connected computer systems or online users. Thus, the data provided from the network 1020 may be in any networking protocol. In one embodiment, network 1020 may be the public internet that serves to provide access to content delivery system 1010 by multiple online users that utilize internet web browsers on personal computers operating through an internet service provider. In this case the data is assumed to follow one or more of various Internet Protocols, such as TCP/IP, UDP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

Examples of content that may be delivered by content delivery system 1010 include, but are not limited to, static content (e.g., web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 1A, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated flowpath through content delivery system 1010. As discussed below, second network connection 1023 may be connected to a second network 1024 (as shown). Alternatively, both network connections 1022 and 1023 may be connected to network 1020.

As shown in FIG. 1A, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 1A content delivery processing engines (or “processing blades”) include network interface processing engine 1030, storage processing engine 1040, network transport/protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

It will be understood with benefit of this disclosure that the particular number and identity of content delivery engines illustrated in FIG. 1A are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 1A, and/or the selected engines may include other types of content delivery engines and/or may not include all of the engine types illustrated in FIG. 1A. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such subtasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the x86 and Pentium processors from Intel Corporation, the SPARC processor from Sun Microsystems, Inc., the PowerPC processor from Motorola, Inc. or any other microcontroller or microprocessor. In addition, network processors (discussed in more detail below) may also be utilized. The modular multi-task configuration of content delivery system 1010 allows the number and/or type of content delivery engines and processors to be selected or varied to fit the needs of a particular application.

The configuration of the content delivery system described above provides scalability without having to scale all the resources of a system. Thus, unlike the traditional rack and stack systems, such as server systems in which an entire server may be added just to expand one segment of system resources, the content delivery system allows the particular resources needed to be the only expanded resources. For example, storage resources may be greatly expanded without having to expand all of the traditional server resources.

Distributive Interconnect

Still referring to FIG. 1A, distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc. Generally, for purposes of this description, a “bus” is any system bus that carries data in a manner that is visible to all nodes on the bus. Generally, some sort of bus arbitration scheme is implemented and data may be carried in parallel, as n-bit words. As distinguished from a bus, a switch fabric establishes independent paths from node to node and data is specifically addressed to a particular node on the switch fabric. Other nodes do not see the data nor are they blocked from creating their own paths. The result is a simultaneous guaranteed bit rate in each direction for each of the switch fabric's ports.

The use of a distributed interconnect 1080 to connect the various processing engines in lieu of the network connections used with the switches of conventional multiserver endpoints is beneficial for several reasons. As compared to network connections, the distributed interconnect 1080 is less error prone, allows more deterministic content delivery, and provides higher bandwidth connections to the various processing engines. The distributed interconnect 1080 also has greatly improved data integrity and throughput rates as compared to network connections.

Use of the distributed interconnect 1080 allows latency between content delivery engines to be short, finite and follow a known path. Known maximum latency specifications are typically associated with the various bus architectures listed above. Thus, when the employed interconnect medium is a bus, latencies fall within a known range. In the case of a switch fabric, latencies are fixed. Further, the connections are “direct”, rather than by some undetermined path. In general, the use of the distributed interconnect 1080 rather than network connections, permits the switching and interconnect capacities of the content delivery system 1010 to be predictable and consistent.

One example interconnection system suitable for use as distributive interconnection 1080 is an 8/16 port 28.4 Gbps high speed PRIZMA-E non-blocking switch fabric switch available from IBM. It will be understood that other switch fabric configurations having greater or lesser numbers of ports, throughput, and capacity are also possible. Among the advantages offered by such a switch fabric interconnection in comparison to shared-bus interface interconnection technology are throughput, scalability and fast and efficient communication between individual discrete content delivery engines of content delivery system 1010. In the embodiment of FIG. 1A, distributive interconnection 1080 facilitates parallel and independent operation of each engine in its own optimized environment without bandwidth interference from other engines, while at the same time providing peer-to-peer communication between the engines on an as-needed basis (e.g., allowing direct communication between any two content delivery engines 1030, 1040, 1050, 1060 and 1070). Moreover, the distributed interconnect may directly transfer inter-processor communications between the various engines of the system. Thus, communication, command and control information may be provided between the various peers via the distributed interconnect. In addition, communication from one peer to multiple peers may be implemented through a broadcast communication which is provided from one peer to all peers coupled to the interconnect. The interface for each peer may be standardized, thus providing ease of design and allowing for system scaling by providing standardized ports for adding additional peers.

Network Interface Processing Engine

As illustrated in FIG. 1A, network interface processing engine 1030 interfaces with network 1020 by receiving and processing requests for content and delivering requested content to network 1020. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Internet Protocol (IP), Wireless Application Protocol (WAP) as well as other networking protocols. Thus the network interface processing engine 1030 may be suitable for handling queue management, buffer management, TCP connect sequence, checksum, IP address lookup, internal load balancing, packet switching, etc. Thus, network interface processing engine 1030 may be employed as illustrated to process or terminate one or more layers of the network protocol stack and to perform look-up intensive operations, offloading these tasks from other content delivery processing engines of content delivery system 1010. Network interface processing engine 1030 may also be employed to load balance among other content delivery processing engines of content delivery system 1010. Both of these features serve to accelerate content delivery, and are enhanced by placement of distributive interchange and protocol termination processing functions on the same board. Examples of other functions that may be performed by network interface processing engine 1030 include, but are not limited to, security processing.

With regard to the network protocol stack, the stack in traditional systems may often be rather large. Processing the entire stack for every request across the distributed interconnect may significantly impact performance. As described herein, the protocol stack has been segmented or “split” between the network interface engine and the transport processing engine. An abbreviated version of the protocol stack is then provided across the interconnect. By utilizing this functionally split version of the protocol stack, increased bandwidth may be obtained. In this manner the communication and data flow through the content delivery system 1010 may be accelerated. The use of a distributed interconnect (for example a switch fabric) further enhances this acceleration as compared to traditional bus interconnects.

The network interface processing engine 1030 may be coupled to the network 1020 through a Gigabit (Gb) Ethernet fiber front end interface 1022. One or more additional Gb Ethernet interfaces 1023 may optionally be provided, for example, to form a second interface with network 1020, or to form an interface with a second network or application 1024 as shown (e.g., to form an interface with one or more server/s for delivery of web cache content, etc.). Regardless of whether the network connection is via Ethernet, or some other means, the network connection could be of any type, with other examples being ATM, SONET, or wireless. The physical medium between the network and the network processor may be copper, optical fiber, wireless, etc.

In one embodiment, network interface processing engine 1030 may utilize a network processor, although it will be understood that in other embodiments a network processor may be supplemented with or replaced by a general purpose processor or an embedded microcontroller. The network processor may be one of the various types of specialized processors that have been designed and marketed to switch network traffic at intermediate nodes. Consistent with this conventional application, these processors are designed to process high speed streams of network packets. In conventional operation, a network processor receives a packet from a port, verifies fields in the packet header, and decides on an outgoing port to which it forwards the packet. The processing of a network processor may be considered as “pass through” processing, as compared to the intensive state modification processing performed by general purpose processors. A typical network processor has a number of processing elements, some operating in parallel and some in pipeline. Often a characteristic of a network processor is that it may hide memory access latency needed to perform lookups and modifications of packet header fields. A network processor may also have one or more network interface controllers, such as a gigabit Ethernet controller, and are generally capable of handling data rates at “wire speeds”.

Examples of network processors include the C-Port processor manufactured by Motorola, Inc., the IXP1200 processor manufactured by Intel Corporation, the Prism processor manufactured by SiTera Inc., and others manufactured by MMC Networks, Inc. and Agere, Inc. These processors are programmable, usually with a RISC or augmented RISC instruction set, and are typically fabricated on a single chip.

The processing cores of a network processor are typically accompanied by special purpose cores that perform specific tasks, such as fabric interfacing, table lookup, queue management, and buffer management. Network processors typically have their memory management optimized for data movement, and have multiple I/O and memory buses. The programming capability of network processors permit them to be programmed for a variety of tasks, such as load balancing, network protocol processing, network security policies, and QoS/CoS support. These tasks can be tasks that would otherwise be performed by another processor. For example, TCP/IP processing may be performed by a network processor at the front end of an endpoint system. Another type of processing that could be offloaded is execution of network security policies or protocols. A network processor could also be used for load balancing. Network processors used in this manner can be referred to as “network accelerators” because their front end “look ahead” processing can vastly increase network response speeds. Network processors perform look ahead processing by operating at the front end of the network endpoint to process network packets in order to reduce the workload placed upon the remaining endpoint resources. Various uses of network accelerators are described in the following U.S. patent applications: Ser. No. 09/797,412, filed Mar. 1, 2001 and entitled “Network Transport Accelerator,” by Bailey et. al; Ser. No. 09/797,507 filed Mar. 1, 2001 and entitled “Single Chassis Network Endpoint System With Network Processor For Load Balancing,” by Richter et. al; and Ser. No. 09/797,411 filed Mar. 1, 2001 and entitled “Network Security Accelerator,” by Canion et. al; the disclosures of which are all incorporated herein by reference. When utilizing network processors in an endpoint environment it may be advantageous to utilize techniques for order serialization of information, such as for example, as disclosed in U.S. patent application Ser. No. 09/797,197, filed Mar. 1, 2001 and entitled “Methods and Systems For The Order Serialization Of Information In A Network Processing Environment,” by Richter et. al, the disclosure of which is incorporated herein by reference.

FIG. 3 illustrates one possible general configuration of a network processor. As illustrated, a set of traffic processors 21 operate in parallel to handle transmission and receipt of network traffic. These processors may be general purpose microprocessors or state machines. Various core processors 22-24 handle special tasks. For example, the core processors 22-24 may handle lookups, checksums, and buffer management. A set of serial data processors 25 provide Layer 1 network support. Interface 26 provides the physical interface to the network 1020. A general purpose bus interface 27 is used for downloading code and configuration tasks. A specialized interface 28 may be specially programmed to optimize the path between network processor 12 and distributed interconnection 1080.

As mentioned above, the network processors utilized in the content delivery system 1010 are utilized for endpoint use, rather than conventional use at intermediate network nodes. In one embodiment, network interface processing engine 1030 may utilize a MOTOROLA C-Port C-5 network processor capable of handling two Gb Ethernet interfaces at wire speed, and optimized for cell and packet processing. This network processor may contain sixteen 200 MHz MIPS processors for cell/packet switching and thirty-two serial processing engines for bit/byte processing, checksum generation/verification, etc. Further processing capability may be provided by five coprocessors that perform the following network specific tasks: supervisor/executive, switch fabric interface, optimized table lookup, queue management, and buffer management. The network processor may be coupled to the network 1020 by using a VITESSE GbE SERDES (serializer-deserializer) device (for example the VSC7123) and an SFP (small form factor pluggable) optical transceiver for LC fiber connection. TRANSPORT/PROTOCOL PROCESSING ENGINE

Referring again to FIG. 1A, transport processing engine 1050 may be provided for performing network transport protocol sub-tasks, such as processing content requests received from network interface engine 1030. Although named a “transport” engine for discussion purposes, it will be recognized that the engine 1050 performs transport and protocol processing and the term transport processing engine is not meant to limit the functionality of the engine. In this regard transport processing engine 1050 may be any hardware or hardware/software subsystem suitable for TCP/UDP processing, other protocol processing, transport processing, etc. In one embodiment transport engine 1050 may be a dedicated TCP/IP processing module based on an INTEL PENTIUM III or MOTOROLA POWERPC 7450 based processor running the Thread-X RTOS environment with protocol stack based on TCP/IP technology.

As compared to traditional server type computing systems, the transport processing engine 1050 may off-load other tasks that traditionally a main CPU may perform. For example, the performance of server CPUs significantly decreases when a large amount of network connections are made merely because the server CPU regularly checks each connection for time outs. The transport processing engine 1050 may perform time out checks for each network connection, session management, data reordering and retransmission, data queuing and flow control, packet header generation, etc. off-loading these tasks from the application processing engine or the network interface processing engine. The transport processing engine 1050 may also handle error checking, likewise freeing up the resources of other processing engines.

Network Interface/Transport Split Protocol

The embodiment of FIG. 1A contemplates that the protocol processing is shared between the transport processing engine 1050 and the network interface engine 1030. This sharing technique may be called “split protocol stack” processing. The division of tasks may be such that higher tasks in the protocol stack are assigned to the transport processor engine. For example, network interface engine 1030 may processes all or some of the TCP/IP protocol stack as well as all protocols lower on the network protocol stack. Another approach could be to assign state modification intensive tasks to the transport processing engine.

In one embodiment related to a content delivery system that receives packets, the network interface engine performs the MAC header identification and verification, IP header identification and verification, IP header checksum validation, TCP and UDP header identification and validation, and TCP or UDP checksum validation. It also may perform the lookup to determine the TCP connection or UDP socket (protocol session identifier) to which a received packet belongs. Thus, the network interface engine verifies packet lengths, checksums, and validity. For transmission of packets, the network interface engine performs TCP or UDP checksum generation, IP header generation, and MAC header generation, IP checksum generation, MAC FCS/CRC generation, etc.

Tasks such as those described above can all be performed rapidly by the parallel and pipeline processors within a network processor. The “fly by” processing style of a network processor permits it to look at each byte of a packet as it passes through, using registers and other alternatives to memory access. The network processor's “stateless forwarding” operation is best suited for tasks not involving complex calculations that require rapid updating of state information.

An appropriate internal protocol may be provided for exchanging information between the network interface engine 1030 and the transport engine 1050 when setting up or terminating a TCP and/or UDP connections and to transfer packets between the two engines. For example, where the distributive interconnection medium is a switch fabric, the internal protocol may be implemented as a set of messages exchanged across the switch fabric. These messages indicate the arrival of new inbound or outbound connections and contain inbound or outbound packets on existing connections, along with identifiers or tags for those connections. The internal protocol may also be used to transfer identifiers or tags between the transport engine 1050 and the application processing engine 1070 and/or the storage processing engine 1040. These identifiers or tags may be used to reduce or strip or accelerate a portion of the protocol stack.

For example, with a TCP/IP connection, the network interface engine 1030 may receive a request for a new connection. The header information associated with the initial request may be provided to the transport processing engine 1050 for processing. That result of this processing may be stored in the resources of the transport processing engine 1050 as state and management information for that particular network session. The transport processing engine 1050 then informs the network interface engine 1030 as to the location of these results. Subsequent packets related to that connection that are processed by the network interface engine 1030 may have some of the header information stripped and replaced with an identifier or tag that is provided to the transport processing engine 1050. The identifier or tag may be a pointer, index or any other mechanism that provides for the identification of the location in the transport processing engine of the previously setup state and management information (or the corresponding network session). In this manner, the transport processing engine 1050 does not have to process the header information of every packet of a connection. Rather, the transport interface engine merely receives a contextually meaningful identifier or tag that identifies the previous processing results for that connection.

In one embodiment, the data link, network, transport and session layers (layers 25) of a packet may be replaced by identifier or tag information. For packets related to an established connection the transport processing engine does not have to perform intensive processing with regard to these layers such as hashing, scanning, look up, etc. operations. Rather, these layers have already been converted (or processed) once in the transport processing engine and the transport processing engine just receives the identifier or tag provided from the network interface engine that identifies the location of the conversion results.

In this manner an identifier label or tag is provided for each packet of an established connection so that the more complex data computations of converting header information may be replaced with a more simplistic analysis of an identifier or tag. The delivery of content is thereby accelerated, as the time for packet processing and the amount of system resources for packet processing are both reduced. The functionality of network processors, which provide efficient parallel processing of packet headers, is well suited for enabling the acceleration described herein. In addition, acceleration is further provided as the physical size of the packets provided across the distributed interconnect may be reduced.

Though described herein with reference to messaging between the network interface engine and the transport processing engine, the use of identifiers or tags may be utilized amongst all the engines in the modular pipelined processing described herein. Thus, one engine may replace packet or data information with contextually meaningful information that may require less processing by the next engine in the data and communication flow path. In addition, these techniques may be utilized for a wide variety of protocols and layers, not just the exemplary embodiments provided herein.

With the above-described tasks being performed by the network interface engine, the transport engine may perform TCP sequence number processing, acknowledgement and retransmission, segmentation and reassembly, and flow control tasks. These tasks generally call for storing and modifying connection state information on each TCP and UDP connection, and therefore are considered more appropriate for the processing capabilities of general purpose processors.

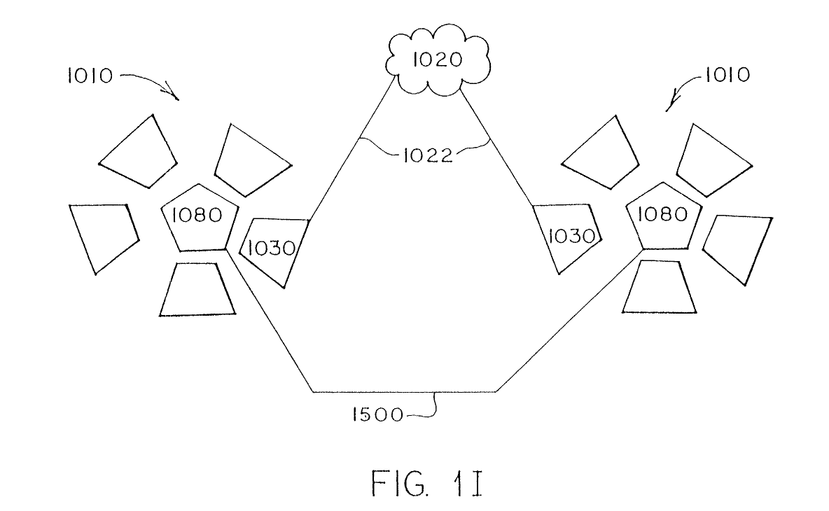

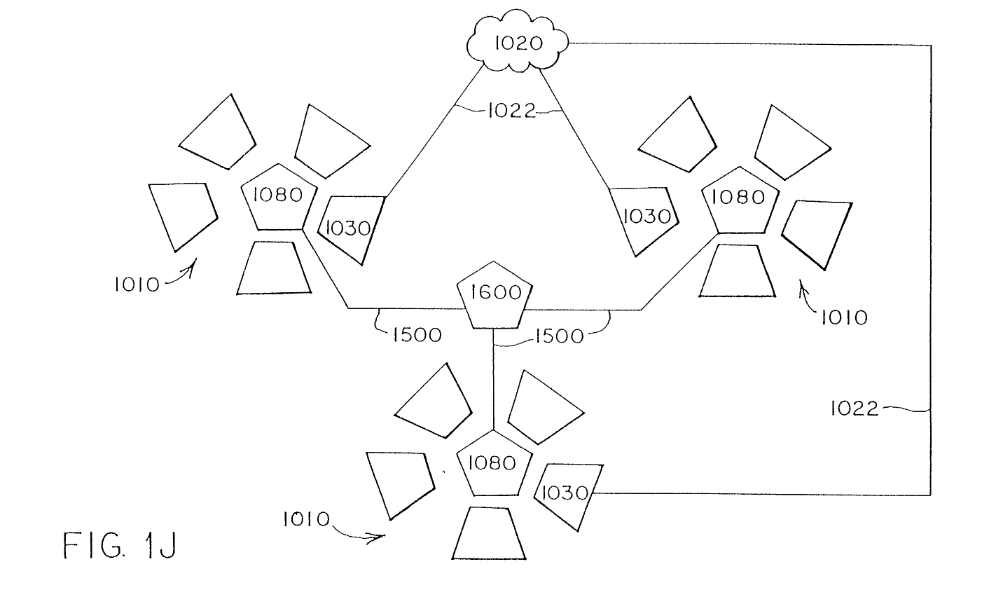

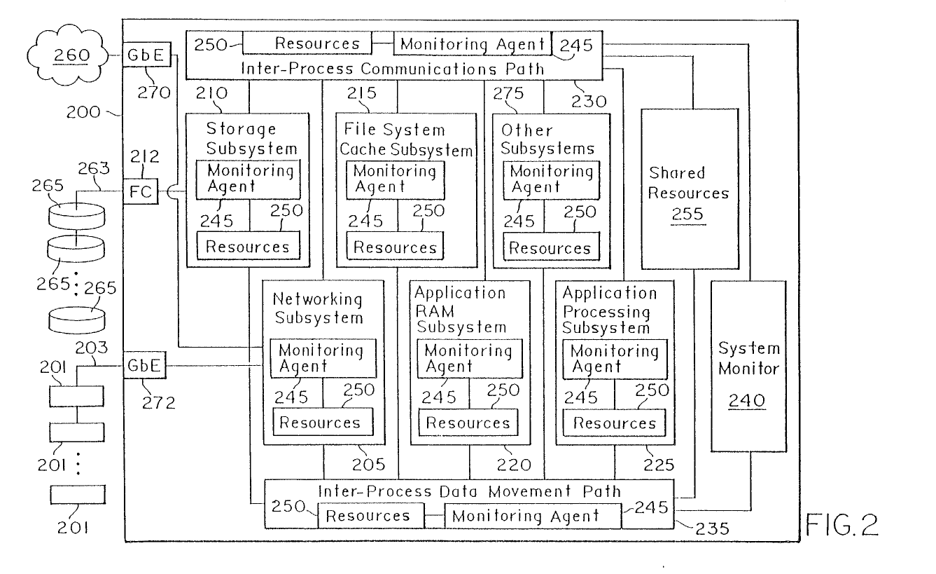

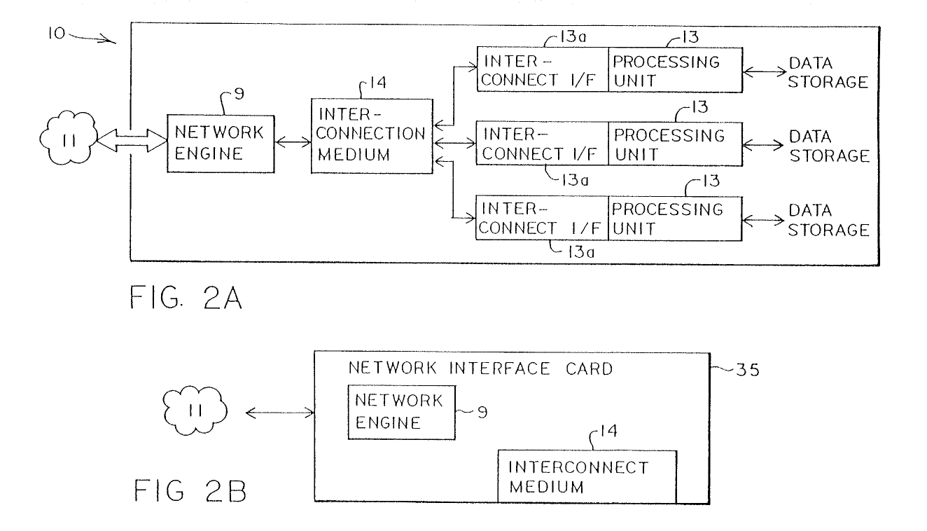

As will be discussed with references to alternative embodiments (such as FIGS. 2 and 2A), the transport engine 1050 and the network interface engine 1030 may be combined into a single engine. Such a combination may be advantageous as communication across the switch fabric is not necessary for protocol processing. However, limitations of many commercially available network processors make the split protocol stack processing described above desirable.

Application Processing Engine

Application processing engine 1070 may be provided in content delivery system 1010 for application processing, and may be, for example, any hardware or hardware/software subsystem suitable for session layer protocol processing (e.g. HTTP, RTSP streaming, etc.) of content requests received from network transport processing engine 1050. In one embodiment application processing engine 1070 may be a dedicated application processing module based on an INTEL PENTIUM III processor running, for example, on standard x86 OS systems (e.g., Linux, Windows NT, FreeBSD, etc.). Application processing engine 1070 may be utilized for dedicated application-only processing by virtue of the off-loading of all network protocol and storage processing elsewhere in content delivery system 1010. In one embodiment, processor programming for application processing engine 1070 may be generally similar to that of a conventional server, but without the tasks off-loaded to network interface processing engine 1030, storage processing engine 1040, and transport processing engine 1050.

Storage Management Engine

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage.

In one embodiment, processor programming for storage management engine 1040 may be optimized for data retrieval using techniques such as caching, and may include and maintain a disk cache to reduce the relatively long time often required to retrieve data from content sources, such as disk drives. Requests received by storage management engine 1040 from application processing engine 1070 may contain information on how requested data is to be formatted and its destination, with this information being comprehensible to transport processing engine 1050 and/or network interface processing engine 1030. The storage management engine 1040 may utilize a disk cache to reduce the relatively long time it may take to retrieve data stored in a storage medium such as disk drives. Upon receiving a request, storage management engine 1040 may be programmed to first determine whether the requested data is cached, and then to send a request for data to the appropriate content source 1090 or 1100. Such a request may be in the form of a conventional read request. The designated content source 1090 or 1100 responds by sending the requested content to storage management engine 1040, which in turn sends the content to transport processing engine 1050 for forwarding to network interface processing engine 1030.

Based on the data contained in the request received from application processing engine 1070, storage processing engine 1040 sends the requested content in proper format with the proper destination data included. Direct communication between storage processing engine 1040 and transport processing engine 1050 enables application processing engine 1070 to be bypassed with the requested content. Storage processing engine 1040 may also be configured to write data to content sources 1090 and/or 1100 (e.g., for storage of live or broadcast streaming content).

In one embodiment storage management engine 1040 may be a dedicated block-level cache processor capable of block level cache processing in support of thousands of concurrent multiple readers, and direct block data switching to network interface engine 1030. In this regard storage management engine 1040 may utilize a POWER PC 7450 processor in conjunction with ECC memory and a LSI SYMFC929 dual 2 GBaud fibre channel controller for fibre channel interconnect to content sources 1090 and/or 1100 via dual fibre channel arbitrated loop 1092. It will be recognized, however, that other forms of interconnection to storage sources suitable for retrieving content are also possible. Storage management engine 1040 may include hardware and/or software for running the Fibre Channel (FC) protocol, the SCSI (Small Computer Systems Interface) protocol, iSCSI protocol as well as other storage networking protocols.

Storage management engine 1040 may employ any suitable method for caching data, including simple computational caching algorithms such as random removal (RR), first-in first-out (FIFO), predictive read-ahead, over buffering, etc. algorithms. Other suitable caching algorithms include those that consider one or more factors in the manipulation of content stored within the cache memory, or which employ multi-level ordering, key based ordering or function based calculation for replacement. In one embodiment, storage management engine may implement a layered multiple LRU (LMLRU) algorithm that uses an integrated block/buffer management structure including at least two layers of a configurable number of multiple LRU queues and a two-dimensional positioning algorithm for data blocks in the memory to reflect the relative priorities of a data block in the memory in terms of both recency and frequency. Such a caching algorithm is described in further detail in U.S. patent application Ser. No. 09/797,198, entitled “Systems and Methods for Management of Memory” by Qiu et. al, the disclosure of which is incorporated herein by reference.

For increasing delivery efficiency of continuous content, such as streaming multimedia content, storage management engine 1040 may employ caching algorithms that consider the dynamic characteristics of continuous content. Suitable examples include, but are not limited to, interval caching algorithms. In one embodiment, improved caching performance of continuous content may be achieved using an LMLRU caching algorithm that weighs ongoing viewer cache value versus the dynamic time-size cost of maintaining particular content in cache memory. Such a caching algorithm is described in further detail in U.S. patent application Ser. No. 09/797,201, filed Mar. 1, 2001 and entitled “Systems and Methods for Management of Memory in Information Delivery Environments” by Qiu et. al, the disclosure of which is incorporated herein by reference.

System Management Engine

System management (or host) engine 1060 may be present to perform system management functions related to the operation of content delivery system 1010. Examples of system management functions include, but are not limited to, content provisioning/updates, comprehensive statistical data gathering and logging for subsystem engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g., individual supplier/user usage of distributive interchange and/or content delivery engines) may be tracked and logged by system management engine 1060, enabling an operator of the content delivery system 1010 to charge each content supplier or user on the basis of content volume delivered.

System management engine 1060 may be any hardware or hardware/software subsystem suitable for performance of one or more such system management engines and in one embodiment may be a dedicated application processing module based, for example, on an INTEL PENTIUM III processor running an x86 OS. Because system management engine 1060 is provided as a discrete modular engine, it may be employed to perform system management functions from within content delivery system 1010 without adversely affecting the performance of the system. Furthermore, the system management engine 1060 may maintain information on processing engine assignment and content delivery paths for various content delivery applications, substantially eliminating the need for an individual processing engine to have intimate knowledge of the hardware it intends to employ.

Under manual or scheduled direction by a user, system management processing engine 1060 may retrieve content from the network 1020 or from one or more external servers on a second network 1024 (e.g., LAN) using, for example, network file system (NFS) or common internet file system (CIFS) file sharing protocol. Once content is retrieved, the content delivery system may advantageously maintain an independent copy of the original content, and therefore is free to employ any file system structure that is beneficial, and need not understand low level disk formats of a large number of file systems.

Management interface 1062 may be provided for interconnecting system management engine 1060 with a network 1200 (e.g., LAN), or connecting content delivery system 1010 to other network appliances such as other content delivery systems 1010, servers, computers, etc. Management interface 1062 may be by any suitable network interface, such as 10/100 Ethernet, and may support communications such as management and origin traffic. Provision for one or more terminal management interfaces (not shown) for may also be provided, such as by RS-232 port, etc. The management interface may be utilized as a secure port to provide system management and control information to the content delivery system 1010. For example, tasks which may be accomplished through the management interface 1062 include reconfiguration of the allocation of system hardware (as discussed below with reference to FIGS. 1C-1F), programming the application processing engine, diagnostic testing, and any other management or control tasks. Though generally content is not envisioned being provided through the management interface, the identification of or location of files or systems containing content may be received through the management interface 1062 so that the content delivery system may access the content through the other higher bandwidth interfaces.

Management Performed by the Network Interface

Some of the system management functionality may also be performed directly within the network interface processing engine 1030. In this case some system policies and filters may be executed by the network interface engine 1030 in real-time at wirespeed. These polices and filters may manage some traffic/bandwidth management criteria and various service level guarantee policies. Examples of such system management functionality of are described below. It will be recognized that these functions may be performed by the system management engine 1060, the network interface engine 1030, or a combination thereof.

For example, a content delivery system may contain data for two web sites. An operator of the content delivery system may guarantee one web site (“the higher quality site”) higher performance or bandwidth than the other web site (“the lower quality site”), presumably in exchange for increased compensation from the higher quality site. The network interface processing engine 1030 may be utilized to determine if the bandwidth limits for the lower quality site have been exceeded and reject additional data requests related to the lower quality site. Alternatively, requests related to the lower quality site may be rejected to ensure the guaranteed performance of the higher quality site is achieved. In this manner the requests may be rejected immediately at the interface to the external network and additional resources of the content delivery system need not be utilized. In another example, storage service providers may use the content delivery system to charge content providers based on system bandwidth of downloads (as opposed to the traditional storage area based fees). For billing purposes, the network interface engine may monitor the bandwidth use related to a content provider. The network interface engine may also reject additional requests related to content from a content provider whose bandwidth limits have been exceeded. Again, in this manner the requests may be rejected immediately at the interface to the external network and additional resources of the content delivery system need not be utilized.

Additional system management functionality, such as quality of service (QoS) functionality, also may be performed by the network interface engine. A request from the external network to the content delivery system may seek a specific file and also may contain Quality of Service (QoS) parameters. In one example, the QoS parameter may indicate the priority of service that a client on the external network is to receive. The network interface engine may recognize the QoS data and the data may then be utilized when managing the data and communication flow through the content delivery system. The request may be transferred to the storage management engine to access this file via a read queue, e.g., [Destination IP][Filename][File Type (CoS)][Transport Priorities (QoS)]. All file read requests may be stored in a read queue. Based on CoS/QoS policy parameters as well as buffer status within the storage management engine (empty, full, near empty, block seq#, etc), the storage management engine may prioritize which blocks of which files to access from the disk next, and transfer this data into the buffer memory location that has been assigned to be transmitted to a specific IP address. Thus based upon QoS data in the request provided to the content delivery system, the data and communication traffic through the system may be prioritized. The QoS and other policy priorities may be applied to both incoming and outgoing traffic flow. Therefore a request having a higher QoS priority may be received after a lower order priority request, yet the higher priority request may be served data before the lower priority request.

The network interface engine may also be used to filter requests that are not supported by the content delivery system. For example, if a content delivery system is configured only to accept HTTP requests, then other requests such as FTP, telnet, etc. may be rejected or filtered. This filtering may be applied directly at the network interface engine, for example by programming a network processor with the appropriate system policies. Limiting undesirable traffic directly at the network interface offloads such functions from the other processing modules and improves system performance by limiting the consumption of system resources by the undesirable traffic. It will be recognized that the filtering example described herein is merely exemplary and many other filter criteria or policies may be provided.

Multi-Processor Module Design

As illustrated in FIG. 1A, any given processing engine of content delivery system 1010 may be optionally provided with multiple processing modules so as to enable parallel or redundant processing of data and/or communications. For example, two or more individual dedicated TCP/UDP processing modules 1050a and 1050b may be provided for transport processing engine 1050, two or more individual application processing modules 1070a and 1070b may be provided for network application processing engine 1070, two or more individual network interface processing modules 1030a and 1030b may be provided for network interface processing engine 1030 and two or more individual storage management processing modules 1040a and 1040b may be provided for storage management processing engine 1040. Using such a configuration, a first content request may be processed between a first TCP/UDP processing module and a first application processing module via a first switch fabric path, at the same time a second content request is processed between a second TCP/UDP processing module and a second application processing module via a second switch fabric path. Such parallel processing capability may be employed to accelerate content delivery.

Alternatively, or in combination with parallel processing capability, a first TCP/UDP processing module 1050a may be backed-up by a second TCP/UDP processing module 1050b that acts as an automatic failover spare to the first module 1050a. In those embodiments employing multiple-port switch fabrics, various combinations of multiple modules may be selected for use as desired on an individual system-need basis (e.g., as may be dictated by module failures and/or by anticipated or actual bottlenecks), limited only by the number of available ports in the fabric. This feature offers great flexibility in the operation of individual engines and discrete processing modules of a content delivery system, which may be translated into increased content delivery acceleration and reduction or substantial elimination of adverse effects resulting from system component failures.

In yet other embodiments, the processing modules may be specialized to specific applications, for example, for processing and delivering HTTP content, processing and delivering RTSP content, or other applications. For example, in such an embodiment an application processing module 1070a and storage processing module 1040a may be specially programmed for processing a first type of request received from a network. In the same system, application processing module 1070b and storage processing module 1040b may be specially programmed to handle a second type of request different from the first type. Routing of requests to the appropriate respective application and/or storage modules may be accomplished using a distributive interconnect and may be controlled by transport and/or interface processing modules as requests are received and processed by these modules using policies set by the system management engine.

Further, by employing processing modules capable of performing the function of more than one engine in a content delivery system, the assigned functionality of a given module may be changed on an as-needed basis, either manually or automatically by the system management engine upon the occurrence of given parameters or conditions. This feature may be achieved, for example, by using similar hardware modules for different content delivery engines (e.g., by employing PENTIUM III based processors for both network transport processing modules and for application processing modules), or by using different hardware modules capable of performing the same task as another module through software programmability (e.g., by employing a POWER PC processor based module for storage management modules that are also capable of functioning as network transport modules). In this regard, a content delivery system may be configured so that such functionality reassignments may occur during system operation, at system boot-up or in both cases. Such reassignments may be effected, for example, using software so that in a given content delivery system every content delivery engine (or at a lower level, every discrete content delivery processing module) is potentially dynamically reconfigurable using software commands. Benefits of engine or module reassignment include maximizing use of hardware resources to deliver content while minimizing the need to add expensive hardware to a content delivery system.

Thus, the system disclosed herein allows various levels of load balancing to satisfy a work request. At a system hardware level, the functionality of the hardware may be assigned in a manner that optimizes the system performance for a given load. At the processing engine level, loads may be balanced between the multiple processing modules of a given processing engine to further optimize the system performance.

Clusters Of Systems

The systems described herein may also be clustered together in groups of two or more to provide additional processing power, storage connections, bandwidth, etc. Communication between two individual systems each configured similar to content delivery system 1010 may be made through network interface 1022 and/or 1023. Thus, one content delivery system could communicate with another content delivery system through the network 1020 and/or 1024. For example, a storage unit in one content delivery system could send data to a network interface engine of another content delivery system. As an example, these communications could be via TCP/IP protocols. Alternatively, the distributed interconnects 1080 of two content delivery systems 1010 may communicate directly. For example, a connection may be made directly between two switch fabrics, each switch fabric being the distributed interconnect 1080 of separate content delivery systems 1010.

FIGS. 1G-1J illustrate four exemplary clusters of content delivery systems 1010. It will be recognized that many other cluster arrangements may be utilized including more or less content delivery systems. As shown in FIGS. 1G-1J, each content delivery system may be configured as described above and include a distributive interconnect 1080 and a network interface processing engine 1030. Interfaces 1022 may connect the systems to a network 1020. As shown in FIG. 1G, two content delivery systems may be coupled together through the interface 1023 that is connected to each system's network interface processing engine 1030. FIG. 1H shows three systems coupled together as in FIG. 1G. The interfaces 1023 of each system may be coupled directly together as shown, may be coupled together through a network or may be coupled through a distributed interconnect (for example a switch fabric).

FIG. 1I illustrates a cluster in which the distributed interconnects 1080 of two systems are directly coupled together through an interface 1500. Interface 1500 may be any communication connection, such as a copper connection, optical fiber, wireless connection, etc. Thus, the distributed interconnects of two or more systems may directly communicate without communication through the processor engines of the content delivery systems 1010. FIG. 1J illustrates the distributed interconnects of three systems directly communicating without first requiring communication through the processor engines of the content delivery systems 1010. As shown in FIG. 1J, the interfaces 1500 each communicate with each other through another distributed interconnect 1600. Distributed interconnect 1600 may be a switched fabric or any other distributed interconnect.

The clustering techniques described herein may also be implemented through the use of the management interface 1062. Thus, communication between multiple content delivery systems 1010 also may be achieved through the management interface 1062

Exemplary Data and Communication Flow Paths

FIG. 1B illustrates one exemplary data and communication flow path configuration among modules of one embodiment of content delivery system 1010. The flow paths shown in FIG. 1B are just one example given to illustrate the significant improvements in data processing capacity and content delivery acceleration that may be realized using multiple content delivery engines that are individually optimized for different layers of the software stack and that are distributively interconnected as disclosed herein. The illustrated embodiment of FIG. 1B employs two network application processing modules 1070a and 1070b, and two network transport processing modules 1050a and 1050b that are communicatively coupled with single storage management processing module 1040a and single network interface processing module 1030a. The storage management processing module 1040a is in turn coupled to content sources 1090 and 1100. In FIG. 1B, inter-processor command or control flow (i.e. incoming or received data request) is represented by dashed lines, and delivered content data flow is represented by solid lines. Command and data flow between modules may be accomplished through the distributive interconnection 1080 (not shown), for example a switch fabric.

As shown in FIG. 1B, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Storage management processing module 1040a then forwards the requested content directly to one of network transport processing modules 1050a or 1050b, utilizing the capability of distributive interconnection 1080 to bypass network application processing modules 1070a and 1070b. The requested content may then be transferred via the network interface processing module 1030a to the external network 1020. Benefits of bypassing the application processing modules with the delivered content include accelerated delivery of the requested content and offloading of workload from the application processing modules, each of which translate into greater processing efficiency and content delivery throughput. In this regard, throughput is generally measured in sustained data rates passed through the system and may be measured in bits per second. Capacity may be measured in terms of the number of files that may be partially cached, the number of TCP/IP connections per second as well as the number of concurrent TCP/IP connections that may be maintained or the number of simultaneous streams of a certain bit rate. In an alternative embodiment, the content may be delivered from the storage management processing module to the application processing module rather than bypassing the application processing module. This data flow may be advantageous if additional processing of the data is desired. For example, it may be desirable to decode or encode the data prior to delivery to the network.

To implement the desired command and content flow paths between multiple modules, each module may be provided with means for identification, such as a component ID. Components may be affiliated with content requests and content delivery to effect a desired module routing. The data-request generated by the network interface engine may include pertinent information such as the component ID of the various modules to be utilized in processing the request. For example, included in the data request sent to the storage management engine may be the component ID of the transport engine that is designated to receive the requested content data. When the storage management engine retrieves the data from the storage device and is ready to send the data to the next engine, the storage management engine knows which component ID to send the data to.

As further illustrated in FIG. 1B, the use of two network transport modules in conjunction with two network application processing modules provides two parallel processing paths for network transport and network application processing, allowing simultaneous processing of separate content requests and simultaneous delivery of separate content through the parallel processing paths, further increasing throughput/capacity and accelerating content delivery. Any two modules of a given engine may communicate with separate modules of another engine or may communicate with the same module of another engine. This is illustrated in FIG. 1B where the transport modules are shown to communicate with separate application modules and the application modules are shown to communicate with the same storage management module.

FIG. 1B illustrates only one exemplary embodiment of module and processing flow path configurations that may be employed using the disclosed method and system. Besides the embodiment illustrated in FIG. 1B, it will be understood that multiple modules may be additionally or alternatively employed for one or more other network content delivery engines (e.g., storage management processing engine, network interface processing engine, system management processing engine, etc.) to create other additional or alternative parallel processing flow paths, and that any number of modules (e.g., greater than two) may be employed for a given processing engine or set of processing engines so as to achieve more than two parallel processing flow paths. For example, in other possible embodiments, two or more different network transport processing engines may pass content requests to the same application unit, or vice-versa.

Thus, in addition to the processing flow paths illustrated in FIG. 1B, it will be understood that the disclosed distributive interconnection system may be employed to create other custom or optimized processing flow paths (e.g., by bypassing and/or interconnecting any given number of processing engines in desired sequence/s) to fit the requirements or desired operability of a given content delivery application. For example, the content flow path of FIG. 1B illustrates an exemplary application in which the content is contained in content sources 1090 and/or 1100 that are coupled to the storage processing engine 1040. However as discussed above with reference to FIG. 1A, remote and/or live broadcast content may be provided to the content delivery system from the networks 1020 and/or 1024 via the second network interface connection 1023. In such a situation the content may be received by the network interface engine 1030 over interface connection 1023 and immediately re-broadcast over interface connection 1022 to the network 1020. Alternatively, content may be proceed through the network interface connection 1023 to the network transport engine 1050 prior to returning to the network interface engine 1030 for re-broadcast over interface connection 1022 to the network 1020 or 1024. In yet another alternative, if the content requires some manner of application processing (for example encoded content that may need to be decoded), the content may proceed all the way to the application engine 1070 for processing. After application processing the content may then be delivered through the network transport engine 1050, network interface engine 1030 to the network 1020 or 1024.

In yet another embodiment, at least two network interface modules 1030a and 1030b may be provided, as illustrated in FIG. 1A. In this embodiment, a first network interface engine 1030a may receive incoming data from a network and pass the data directly to the second network interface engine 1030b for transport back out to the same or different network. For example, in the remote or live broadcast application described above, first network interface engine 1030a may receive content, and second network interface engine 1030b provide the content to the network 1020 to fulfill requests from one or more clients for this content. Peer-to-peer level communication between the two network interface engines allows first network interface engine 1030a to send the content directly to second network interface engine 1030b via distributive interconnect 1080. If necessary, the content may also be routed through transport processing engine 1050, or through transport processing engine 1050 and application processing engine 1070, in a manner described above.

Still yet other applications may exist in which the content required to be delivered is contained both in the attached content sources 1090 or 1100 and at other remote content sources. For example in a web caching application, not all content may be cached in the attached content sources, but rather some data may also be cached remotely. In such an application, the data and communication flow may be a combination of the various flows described above for content provided from the content sources 1090 and 1100 and for content provided from remote sources on the networks 1020 and/or 1024.

The content delivery system 1010 described above is configured in a peer-to-peer manner that allows the various engines and modules to communicate with each other directly as peers through the distributed interconnect. This is contrasted with a traditional server architecture in which there is a main CPU. Furthermore unlike the arbitrated bus of traditional servers, the distributed interconnect 1080 provides a switching means which is not arbitrated and allows multiple simultaneous communications between the various peers. The data and communication flow may by-pass unnecessary peers such as the return of data from the storage management processing engine 1040 directly to the network interface processing engine 1030 as described with reference to FIG. 1B.

Communications between the various processor engines may be made through the use of a standardized internal protocol. Thus, a standardized method is provided for routing through the switch fabric and communicating between any two of the processor engines which operate as peers in the peer to peer environment. The standardized internal protocol provides a mechanism upon which the external network protocols may “ride” upon or be incorporated within. In this manner additional internal protocol layers relating to internal communication and data exchange may be added to the external protocol layers. The additional internal layers may be provided in addition to the external layers or may replace some of the external protocol layers (for example as described above portions of the external headers may be replaced by identifiers or tags by the network interface engine).

The standardized internal protocol may consist of a system of message classes, or types, where the different classes can independently include fields or layers that are utilized to identify the destination processor engine or processor module for communication, control, or data messages provided to the switch fabric along with information pertinent to the corresponding message class. The standardized internal protocol may also include fields or layers that identify the priority that a data packet has within the content delivery system. These priority levels may be set by each processing engine based upon system-wide policies. Thus, some traffic within the content delivery system may be prioritized over other traffic and this priority level may be directly indicated within the internal protocol call scheme utilized to enable communications within the system. The prioritization helps enable the predictive traffic flow between engines and end-to-end through the system such that service level guarantees may be supported.

Other internally added fields or layers may include processor engine state, system timestamps, specific message class identifiers for message routing across the switch fabric and at the receiving processor engine(s), system keys for secure control message exchange, flow control information to regulate control and data traffic flow and prevent congestion, and specific address tag fields that allow hardware at the receiving processor engines to move specific types of data directly into system memory.

In one embodiment, the internal protocol may be structured as a set, or system of messages with common system defined headers that allows all processor engines and, potentially, processor engine switch fabric attached hardware, to interpret and process messages efficiently and intelligently. This type of design allows each processing engine, and specific functional entities within the processor engines, to have their own specific message classes optimized functionally for the exchanging their specific types control and data information. Some message classes that may be employed are: System Control messages for system management, Network Interface to Network Transport messages, Network Transport to Application Interface messages, File System to Storage engine messages, Storage engine to Network Transport messages, etc. Some of the fields of the standardized message header may include message priority, message class, message class identifier (subtype), message size, message options and qualifier fields, message context identifiers or tags, etc. In addition, the system statistics gathering, management and control of the various engines may be performed across the switch fabric connected system using the messaging capabilities.

By providing a standardized internal protocol, overall system performance may be improved. In particular, communication speed between the processor engines across the switch fabric may be increased. Further, communications between any two processor engines may be enabled. The standardized protocol may also be utilized to reduce the processing loads of a given engine by reducing the amount of data that may need to be processed by a given engine.

The internal protocol may also be optimized for a particular system application, providing further performance improvements. However, the standardized internal communication protocol may be general enough to support encapsulation of a wide range of networking and storage protocols. Further, while internal protocol may run on PCI, PCI-X, ATM, IB, Lightening I/O, the internal protocol is a protocol above these transport-level standards and is optimal for use in a switched (non-bus) environment such as a switch fabric. In addition, the internal protocol may be utilized to communicate devices (or peers) connected to the system in addition to those described herein. For example, a peer need not be a processing engine. In one example, a peer may be an ASIC protocol converter that is coupled to the distributed interconnect as a peer but operates as a slave device to other master devices within the system. The internal protocol may also be as a protocol communicated between systems such as used in the clusters described above.

Thus a system has been provided in which the networking/server clustering/storage networking has been collapsed into a single system utilizing a common low-overhead internal communication protocol/transport system.

Content Delivery Acceleration

As described above, a wide range of techniques have been provided for accelerating content delivery from the content delivery system 1010 to a network. By accelerating the speed at which content may be delivered, a more cost effective and higher performance system may be provided. These techniques may be utilized separately or in various combinations.

One content acceleration technique involves the use of a multi-engine system with dedicated engines for varying processor tasks. Each engine can perform operations independently and in parallel with the other engines without the other engines needing to freeze or halt operations. The engines do not have to compete for resources such as memory, I/O, processor time, etc. but are provided with their own resources. Each engine may also be tailored in hardware and/or software to perform specific content delivery task, thereby providing increasing content delivery speeds while requiring less system resources. Further, all data, regardless of the flow path, gets processed in a staged pipeline fashion such that each engine continues to process its layer of functionality after forwarding data to the next engine/layer.

Content acceleration is also obtained from the use of multiple processor modules within an engine. In this manner, parallelism may be achieved within a specific processing engine. Thus, multiple processors responding to different content requests may be operating in parallel within one engine.

Content acceleration is also provided by utilizing the multi-engine design in a peer to peer environment in which each engine may communicate as a peer. Thus, the communications and data paths may skip unnecessary engines. For example, data may be communicated directly from the storage processing engine to the transport processing engine without have to utilize resources of the application processing engine.

Acceleration of content delivery is also achieved by removing or stripping the contents of some protocol layers in one processing engine and replacing those layers with identifiers or tags for use with the next processor engine in the data or communications flow path. Thus, the processing burden placed on the subsequent engine may be reduced. In addition, the packet size transmitted across the distributed interconnect may be reduced. Moreover, protocol processing may be off-loaded from the storage and/or application processors, thus freeing those resources to focus on storage or application processing.

Content acceleration is also provided by using network processors in a network endpoint system. Network processors generally are specialized to perform packet analysis functions at intermediate network nodes, but in the content delivery system disclosed the network processors have been adapted for endpoint functions. Furthermore, the parallel processor configurations within a network processor allow these endpoint functions to be performed efficiently.

In addition, content acceleration has been provided through the use of a distributed interconnection such as a switch fabric. A switch fabric allows for parallel communications between the various engines and helps to efficiently implement some of the acceleration techniques described herein.

It will be recognized that other aspects of the content delivery system 1010 also provide for accelerated delivery of content to a network connection. Further, it will be recognized that the techniques disclosed herein may be equally applicable to other network endpoint systems and even non-endpoint systems.

Exemplary Hardware Embodiments

FIGS. 1C-1F illustrate just a few of the many multiple network content delivery engine configurations possible with one exemplary hardware embodiment of content delivery system 1010. In each illustrated configuration of this hardware embodiment, content delivery system 1010 includes processing modules that may be configured to operate as content delivery engines 1030, 1040, 1050, 1060, and 1070 communicatively coupled via distributive interconnection 1080. As shown in FIG. 1C, a single processor module may operate as the network interface processing engine 1030 and a single processor module may operate as the system management processing engine 1060. Four processor modules 1001 may be configured to operate as either the transport processing engine 1050 or the application processing engine 1070. Two processor modules 1003 may operate as either the storage processing engine 1040 or the transport processing engine 1050. The Gigabit (Gb) Ethernet front end interface 1022, system management interface 1062 and dual fibre channel arbitrated loop 1092 are also shown.

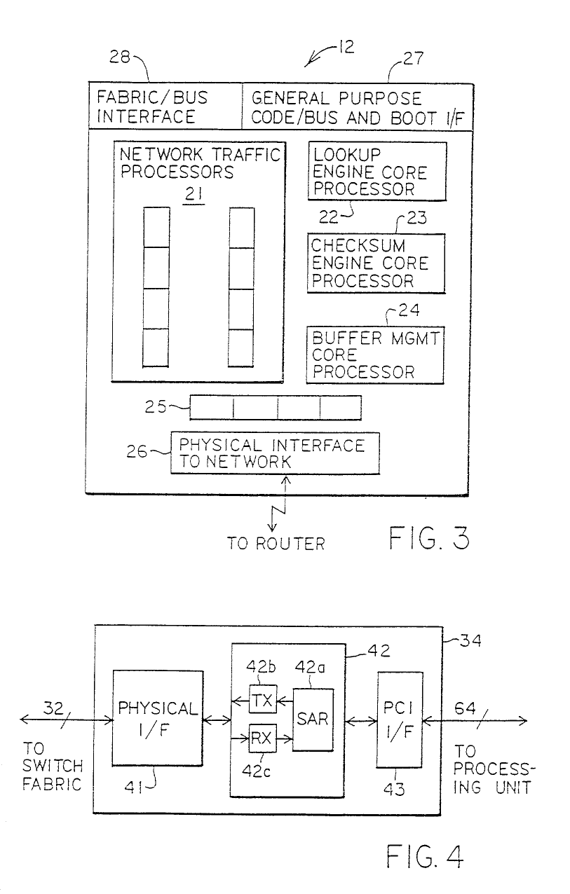

As mentioned above, the distributive interconnect 1080 may be a switch fabric based interconnect. As shown in FIG. 1C, the interconnect may be an IBM PRIZMA-E eight/sixteen port switch fabric 1081. In an eight port mode, this switch fabric is an 8×3.54 Gbps fabric and in a sixteen port mode, this switch fabric is a 16×1.77 Gbps fabric. The eight/sixteen port switch fabric may be utilized in an eight port mode for performance optimization. The switch fabric 1081 may be coupled to the individual processor modules through interface converter circuits 1082, such as IBM UDASL switch interface circuits. The interface converter circuits 1082 convert the data aligned serial link interface (DASL) to a UTOPIA (Universal Test and Operations PHY Interface for ATM) parallel interface. FPGAs (field programmable gate array) may be utilized in the processor modules as a fabric interface on the processor modules as shown in FIG. 1C. These fabric interfaces provide a 64/66 Mhz PCI interface to the interface converter circuits 1082. FIG. 4 illustrates a functional block diagram of such a fabric interface 34. As explained below, the interface 34 provides an interface between the processor module bus and the UDASL switch interface converter circuit 1082. As shown in FIG. 4, at the switch fabric side, a physical connection interface 41 provides connectivity at the physical level to the switch fabric. An example of interface 41 is a parallel bus interface complying with the UTOPIA standard. In the example of FIG. 4, interface 41 is a UTOPIA 3 interface providing a 32-bit 110 Mhz connection. However, the concepts disclosed herein are not protocol dependent and the switch fabric need not comply with any particular ATM or non ATM standard.

Still referring to FIG. 4, SAR (segmentation and reassembly) unit 42 has appropriate SAR logic 42a for performing segmentation and reassembly tasks for converting messages to fabric cells and vice-versa as well as message classification and message class-to-queue routing, using memory 42b and 42c for transmit and receive queues. This permits different classes of messages and permits the classes to have different priority. For example, control messages can be classified separately from data messages, and given a different priority. All fabric cells and the associated messages may be self routing, and no out of band signaling is required.

A special memory modification scheme permits one processor module to write directly into memory of another. This feature is facilitated by switch fabric interface 34 and in particular by its message classification capability. Commands and messages follow the same path through switch fabric interface 34, but can be differentiated from other control and data messages. In this manner, processes executing on processor modules can communicate directly using their own memory spaces.

Bus interface 43 permits switch fabric interface 34 to communicate with the processor of the processor module via the module device or I/O bus. An example of a suitable bus architecture is a PCI architecture, but other architectures could be used. Bus interface 43 is a master/target device, permitting interface 43 to write and be written to and providing appropriate bus control. The logic circuitry within interface 43 implements a state machine that provides the communications protocol, as well as logic for configuration and parity.

Referring again to FIG. 1C, network processor 1032 (for example a MOTOROLA C-Port C-5 network processor) of the network interface processing engine 1030 may be coupled directly to an interface converter circuit 1082 as shown. As mentioned above and further shown in FIG. 1C, the network processor 1032 also may be coupled to the network 1020 by using a VITESSE GbE SERDES (serializer-deserializer) device (for example the VSC7123) and an SFP (small form factor pluggable) optical transceiver for LC fibre connection.

The processor modules 1003 include a fibre channel (FC) controller as mentioned above and further shown in FIG. 1C. For example, the fibre channel controller may be the LSI SYMFC929 dual 2 GBaud fibre channel controller. The fibre channel controller enables communication with the fibre channel 1092 when the processor module 1003 is utilized as a storage processing engine 1040. Also illustrated in FIGS. 1C-1F is optional adjunct processing unit 1300 that employs a POWER PC processor with SDRAM. The adjunct processing unit is shown coupled to network processor 1032 of network interface processing engine 1030 by a PCI interface. Adjunct processing unit 1300 may be employed for monitoring system parameters such as temperature, fan operation, system health, etc.

As shown in FIGS. 1C-1F, each processor module of content delivery engines 1030, 1040, 1050, 1060, and 1070 is provided with its own synchronous dynamic random access memory (“SDRAM”) resources, enhancing the independent operating capabilities of each module. The memory resources may be operated as ECC (error correcting code) memory. Network interface processing engine 1030 is also provided with static random access memory (“SRAM”). Additional memory circuits may also be utilized as will be recognized by those skilled in the art. For example, additional memory resources (such as synchronous SRAM and non-volatile FLASH and EEPROM) may be provided in conjunction with the fibre channel controllers. In addition, boot FLASH memory may also be provided on the of the processor modules.

The processor modules 1001 and 1003 of FIG. 1C may be configured in alternative manners to implement the content delivery processing engines such as the network interface processing engine 1030, storage processing engine 1040, transport processing engine 1050, system management processing engine 1060, and application processing engine 1070. Exemplary configurations are shown in FIGS. 1D-1F, however, it will be recognized that other configurations may be utilized.

As shown in FIG. 1D, two Pentium III based processing modules may be utilized as network application processing modules 1070a and 1070b of network application processing engine 1070. The remaining two Pentium III-based processing modules are shown in FIG. 1D configured as network transport/protocol processing modules 1050a and 1050b of network transport/protocol processing engine 1050. The embodiment of FIG. 1D also includes two POWER PC-based processor modules, configured as storage management processing modules 1040a and 1040b of storage management processing engine 1040. A single MOTOROLA C-Port C-5 based network processor is shown employed as network interface processing engine 1030, and a single Pentium III-based processing module is shown employed as system management processing engine 1060.

In FIG. 1E, the same hardware embodiment of FIG. 1C is shown alternatively configured so that three Pentium III-based processing modules function as network application processing modules 1070a, 1070b and 1070c of network application processing engine 1070, and so that the sole remaining Pentium III-based processing module is configured as a network transport processing module 1050a of network transport processing engine 1050. As shown, the remaining processing modules are configured as in FIG. 1D.

In FIG. 1F, the same hardware embodiment of FIG. 1C is shown in yet another alternate configuration so that three Pentium III-based processing modules function as application processing modules 1070a, 1070b and 1070c of network application processing engine 1070. In addition, the network transport processing engine 1050 includes one Pentium III-based processing module that is configured as network transport processing module 1050a, and one POWER PC-based processing module that is configured as network transport processing module 1050b. The remaining POWER PC-based processor module is configured as storage management processing module 1040a of storage management processing engine 1040.

It will be understood with benefit of this disclosure that the hardware embodiment and multiple engine configurations thereof illustrated in FIGS. 1C-1F are exemplary only, and that other hardware embodiments and engine configurations thereof are also possible. It will further be understood that in addition to changing the assignments of individual processing modules to particular processing engines, distributive interconnect 1080 enables the various processing flow paths between individual modules employed in a particular engine configuration in a manner as described in relation to FIG. 1B. Thus, for any given hardware embodiment and processing engine configuration, a number of different processing flow paths may be employed so as to optimize system performance to suit the needs of particular system applications.

Single Chassis Design

As mentioned above, the content delivery system 1010 may be implemented within a single chassis, such as for example, a 2U chassis. The system may be expanded further while still remaining a single chassis system. In particular, utilizing a multiple processor module or blade arrangement connected through a distributive interconnect (for example a switch fabric) provides a system that is easily scalable. The chassis and interconnect may be configured with expansion slots provided for adding additional processor modules. Additional processor modules may be provided to implement additional applications within the same chassis. Alternatively, additional processor modules may be provided to scale the bandwidth of the network connection. Thus, though describe with respect to a 1 Gbps Ethernet connection to the external network, a 10 Gbps, 40 Gbps or more connection may be established by the system through the use of more network interface modules. Further, additional processor modules may be added to address a system's particular bottlenecks without having to expand all engines of the system. The additional modules may be added during a systems initial configuration, as an upgrade during system maintenance or even hot plugged during system operation.

Alternative Systems Configurations

Further, the network endpoint system techniques disclosed herein may be implemented in a variety of alternative configurations that incorporate some, but not necessarily all, of the concepts disclosed herein. For example, FIGS. 2 and 2A disclose two exemplary alternative configurations. It will be recognized, however, that many other alternative configurations may be utilized while still gaining the benefits of the inventions disclosed herein.

FIG. 2 is a more generalized and functional representation of a content delivery system showing how such a system may be alternately configured to have one or more of the features of the content delivery system embodiments illustrated in FIGS. 1A-1F. FIG. 2 shows content delivery system 200 coupled to network 260 from which content requests are received and to which content is delivered. Content sources 265 are shown coupled to content delivery system 200 via a content delivery flow path 263 that may be, for example, a storage area network that links multiple content sources 265. A flow path 203 may be provided to network connection 272, for example, to couple content delivery system 200 with other network appliances, in this case one or more servers 201 as illustrated in FIG. 2.

In FIG. 2 content delivery system 200 is configured with multiple processing and memory modules that are distributively interconnected by inter-process communications path 230 and inter-process data movement path 235. Inter-process communications path 230 is provided for receiving and distributing inter-processor command communications between the modules and network 260, and interprocess data movement path 235 is provided for receiving and distributing inter-processor data among the separate modules. As illustrated in FIGS. 1A-1F, the functions of inter-process communications path 230 and inter-process data movement path 235 may be together handled by a single distributive interconnect 1080 (such as a switch fabric, for example), however, it is also possible to separate the communications and data paths as illustrated in FIG. 2, for example using other interconnect technology.

FIG. 2 illustrates a single networking subsystem processor module 205 that is provided to perform the combined functions of network interface processing engine 1030 and transport processing engine 1050 of FIG. 1A. Communication and content delivery between network 260 and networking subsystem processor module 205 are made through network connection 270. For certain applications, the functions of network interface processing engine 1030 and transport processing engine 1050 of FIG. 1A may be so combined into a single module 205 of FIG. 2 in order to reduce the level of communication and data traffic handled by communications path 230 and data movement path 235 (or single switch fabric), without adversely impacting the resources of application processing engine or subsystem module. If such a modification were made to the system of FIG. 1A, content requests may be passed directly from the combined interface/transport engine to network application processing engine 1070 via distributive interconnect 1080. Thus, as previously described the functions of two or more separate content delivery system engines may be combined as desired (e.g., in a single module or in multiple modules of a single processing blade), for example, to achieve advantages in efficiency or cost.

In the embodiment of FIG. 2, the function of network application processing engine 1070 of FIG. 1A is performed by application processing subsystem module 225 of FIG. 2 in conjunction with application RAM subsystem module 220 of FIG. 2. System monitor module 240 communicates with server/s 201 through flow path 203 and Gb Ethernet network interface connection 272 as also shown in FIG. 2. The system monitor module 240 may provide the function of the system management engine 1060 of FIG. 1A and/or other system policy/filter functions such as may also be implemented in the network interface processing engine 1030 as described above with reference to FIG. 1A.

Similarly, the function of network storage management engine 1040 is performed by storage subsystem module 210 in conjunction with file system cache subsystem module 215. Communication and content delivery between content sources 265 and storage subsystem module 210 are shown made directly through content delivery flowpath 263 through fibre channel interface connection 212. Shared resources subsystem module 255 is shown provided for access by each of the other subsystem modules and may include, for example, additional processing resources, additional memory resources such as RAM, etc.

Additional processing engine capability (e.g., additional system management processing capability, additional application processing capability, additional storage processing capability, encryption/decryption processing capability, compression/decompression processing capability, encoding/decoding capability, other processing capability, etc.) may be provided as desired and is represented by other subsystem module 275. Thus, as previously described the functions of a single network processing engine may be sub-divided between separate modules that are distributively interconnected. The sub-division of network processing engine tasks may also be made for reasons of efficiency or cost, and/or may be taken advantage of to allow resources (e.g., memory or processing) to be shared among separate modules. Further, additional shared resources may be made available to one or more separate modules as desired.

Also illustrated in FIG. 2 are optional monitoring agents 245 and resources 250. In the embodiment of FIG. 2, each monitoring agent 245 may be provided to monitor the resources 250 of its respective processing subsystem module, and may track utilization of these resources both within the overall system 200 and within its respective processing subsystem module. Examples of resources that may be so monitored and tracked include, but are not limited to, processing engine bandwidth, Fibre Channel bandwidth, number of available drives, IOPS (input/output operations per second) per drive and RAID (redundant array of inexpensive discs) levels of storage devices, memory available for caching blocks of data, table lookup engine bandwidth, availability of RAM for connection control structures and outbound network bandwidth availability, shared resources (such as RAM) used by streaming application on a per-stream basis as well as for use with connection control structures and buffers, bandwidth available for message passing between subsystems, bandwidth available for passing data between the various subsystems, etc.

Information gathered by monitoring agents 245 may be employed for a wide variety of purposes including for billing of individual content suppliers and/or users for pro-rata use of one or more resources, resource use analysis and optimization, resource health alarms, etc. In addition, monitoring agents may be employed to enable the deterministic delivery of content by system 200 as described further herein.

In operation, content delivery system 200 of FIG. 2 may be configured to wait for a request for content or services prior to initiating content delivery or performing a service. A request for content, such as a request for access to data, may include, for example, a request to start a video stream, a request for stored data, etc. A request for services may include, for example, a request for to run an application, to store a file, etc. A request for content or services may be received from a variety of sources. For example, if content delivery system 200 is employed as a stream server, a request for content may be received from a client system attached to a computer network or communication network such as the Internet. In a larger system environment, e.g., a data center, a request for content or services may be received from a separate subcomponent or a system management processing engine, that is responsible for performance of the overall system or from a sub-component that is unable to process the current request. Similarly, a request for content or services may be received by a variety of components of the receiving system. For example, if the receiving system is a stream server, networking subsystem processor module 205 might receive a content request. Alternatively, if the receiving system is a component of a larger system, e.g., a data center, system management processing engine may be employed to receive the request.

Upon receipt of a request for content or services, the request may be filtered by system monitor 240. Such filtering may serve as a screening agent to filter out requests that the receiving system is not capable of processing (e.g., requests for file writes from read-only system embodiments, unsupported protocols, content/services unavailable on system 200, etc.). Such requests may be rejected outright and the requestor notified, may be re-directed to a server 201 or other content delivery system 200 capable of handling the request, or may be disposed of any other desired manner.

Referring now in more detail to one embodiment of FIG. 2 as may be employed in a stream server configuration, networking processing subsystem module 205 may include the hardware and/or software used to run TCP/IP (Transmission Control Protocol/Internet Protocol), UDP/IP (User Datagram Protocol/Internet Protocol), RTP (Real-Time Transport Protocol), Internet Protocol (IP), Wireless Application Protocol (WAP) as well as other networking protocols. Network interface connections 270 and 272 may be considered part of networking subsystem processing module 205 or as separate components. Storage subsystem module 210 may include hardware and/or software for running the Fibre Channel (FC) protocol, the SCSI (Small Computer Systems Interface) protocol, iSCSI protocol as well as other storage networking protocols. FC interface 212 to content delivery flowpath 263 may be considered part of storage subsystem module 210 or as a separate component. File system cache subsystem module 215 may include, in addition to cache hardware, one or more cache management algorithms as well as other software routines.

Application RAM subsystem module 220 may function as a memory allocation subsystem and application processing subsystem module 225 may function as a stream-serving application processor bandwidth subsystem. Among other services, application RAM subsystem module 220 and application processing subsystem module 225 may be used to facilitate such services as the pulling of content from storage and/or cache, the formatting of content into RTSP (Real-Time Streaming Protocol) or another streaming protocol as well the passing of the formatted content to networking subsystem 205.

As previously described, system monitor module 240 may be included in content delivery system 200 to manage one or more of the subsystem processing modules, and may also be used to facilitate communication between the modules.

In part to allow communications between the various subsystem modules of content delivery system 200, inter-process communication path 230 may be included in content delivery system 200, and may be provided with its own monitoring agent 245. Inter-process communications path 230 may be a reliable protocol path employing a reliable IPC (Inter-process Communications) protocol. To allow data or information to be passed between the various subsystem modules of content delivery system 200, interprocess data movement path 235 may also be included in content delivery system 200, and may be provided with its own monitoring agent 245. As previously described, the functions of inter-process communications path 230 and inter-process data movement path 235 may be together handled by a single distributive interconnect 1080, that may be a switch fabric configured to support the bandwidth of content being served.

In one embodiment, access to content source 265 may be provided via a content delivery flow path 263 that is a fibre channel storage area network (SAN), a switched technology. In addition, network connectivity may be provided at network connection 270 (e.g., to a front end network) and/or at network connection 272 (e.g., to a back end network) via switched gigabit Ethernet in conjunction with the switch fabric internal communication system of content delivery system 200. As such, that the architecture illustrated in FIG. 2 may be generally characterized as equivalent to a networking system.

One or more shared resources subsystem modules 255 may also be included in a stream server embodiment of content delivery system 200, for sharing by one or more of the other subsystem modules. Shared resources subsystem module 255 may be monitored by the monitoring agents 245 of each subsystem sharing the resources. The monitoring agents 245 of each subsystem module may also be capable of tracking usage of shared resources 255. As previously described, shared resources may include RAM (Random Access Memory) as well as other types of shared resources.

Each monitoring agent 245 may be present to monitor one or more of the resources 250 of its subsystem processing module as well as the utilization of those resources both within the overall system and within the respective subsystem processing module. For example, monitoring agent 245 of storage subsystem module 210 may be configured to monitor and track usage of such resources as processing engine bandwidth, Fibre Channel bandwidth to content delivery flow path 263, number of storage drives attached, number of input/output operations per second (IOPS) per drive and RAID levels of storage devices that may be employed as content sources 265. Monitoring agent 245 of file system cache subsystem module 215 may be employed monitor and track usage of such resources as processing engine bandwidth and memory employed for caching blocks of data. Monitoring agent 245 of networking subsystem processing module 205 may be employed to monitor and track usage of such resources as processing engine bandwidth, table lookup engine bandwidth, RAM employed for connection control structures and outbound network bandwidth availability. Monitoring agent 245 of application processing subsystem module 225 may be employed to monitor and track usage of processing engine bandwidth. Monitoring agent 245 of application RAM subsystem module 220 may be employed to monitor and track usage of shared resource 255, such as RAM, which may be employed by a streaming application on a per-stream basis as well as for use with connection control structures and buffers. Monitoring agent 245 of interprocess communication path 230 may be employed to monitor and track usage of such resources as the bandwidth used for message passing between subsystems while monitoring agent 245 of inter-process data movement path 235 may be employed to monitor and track usage of bandwidth employed for passing data between the various subsystem modules.

The discussion concerning FIG. 2 above has generally been oriented towards a system designed to deliver streaming content to a network such as the Internet using, for example, Real Networks, Quick Time or Microsoft Windows Media streaming formats. However, the disclosed systems and methods may be deployed in any other type of system operable to deliver content, for example, in web serving or file serving system environments. In such environments, the principles may generally remain the same. However for application processing embodiments, some differences may exist in the protocols used to communicate and the method by which data delivery is metered (via streaming protocol, versus TCP/IP windowing).

FIG. 2A illustrates an even more generalized network endpoint computing system that may incorporate at least some of the concepts disclosed herein. As shown in FIG. 2A, a network endpoint system 10 may be coupled to an external network 11. The external network 11 may include a network switch or router coupled to the front end of the endpoint system 10. The endpoint system 10 may be alternatively coupled to some other intermediate network node of the external network. The system 10 may further include a network engine 9 coupled to an interconnect medium 14. The network engine 9 may include one or more network processors. The interconnect medium 14 may be coupled to a plurality of processor units 13 through interfaces 13a. Each processor unit 13 may optionally be couple to data storage (in the exemplary embodiment shown each unit is couple to data storage). More or less processor units 13 may be utilized than shown in FIG. 2A.

The network engine 9 may be a processor engine that performs all protocol stack processing in a single processor module or alternatively may be two processor modules (such as the network interface engine 1030 and transport engine 1050 described above) in which split protocol stack processing techniques are utilized. Thus, the functionality and benefits of the content delivery system 1010 described above may be obtained with the system 10. The interconnect medium 14 may be a distributive interconnection (for example a switch fabric) as described with reference to FIG. 1A. All of the various computing, processing, communication, and control techniques described above with reference to FIGS. 1A-1F and 2 may be implemented within the system 10. It will therefore be recognized that these techniques may be utilized with a wide variety of hardware and computing systems and the techniques are not limited to the particular embodiments disclosed herein.

The system 10 may consist of a variety of hardware configurations. In one configuration the network engine 9 may be a stand-alone device and each processing unit 13 may be a separate server. In another configuration the network engine 9 may be configured within the same chassis as the processing units 13 and each processing unit 13 may be a separate server card or other computing system. Thus, a network engine (for example an engine containing a network processor) may provide transport acceleration and be combined with multi-server functionality within the system 10. The system 10 may also include shared management and interface components. Alternatively, each processing unit 13 may be a processing engine such as the transport processing engine, application engine, storage engine, or system management engine of FIG. 1A. In yet another alternative, each processing unit may be a processor module (or processing blade) of the processor engines shown in the system of FIG. 1A.

FIG. 2B illustrates yet another use of a network engine 9. As shown in FIG. 2B, a network engine 9 may be added to a network interface card 35. The network interface card 35 may further include the interconnect medium 14 which may be similar to the distributed interconnect 1080 described above. The network interface card may be part of a larger computing system such as a server. The network interface card may couple to the larger system through the interconnect medium 14. In addition to the functions described above, the network engine 9 may perform all traditional functions of a network interface card.

It will be recognized that all the systems described above (FIGS. 1A, 2, 2A, and 2B) utilize a network engine between the external network and the other processor units that are appropriate for the function of the particular network node. The network engine may therefore offload tasks from the other processors. The network engine also may perform “look ahead processing” by performing processing on a request before the request reaches whatever processor is to perform whatever processing is appropriate for the network node. In this manner, the system operations may be accelerated and resources utilized more efficiently.

It will be understood with benefit of this disclosure that although specific exemplary embodiments of hardware and software have been described herein, other combinations of hardware and/or software may be employed to achieve one or more features of the disclosed systems and methods. For example, various and differing hardware platform configurations may be built to support one or more aspects of deterministic functionality described herein including, but not limited to other combinations of defined and monitored subsystems, as well as other types of distributive interconnection technologies to interface between components and subsystems for control and data flow. Furthermore, it will be understood that operating environment and application code may be modified as necessary to implement one or more aspects of the disclosed technology, and that the disclosed systems and methods may be implemented using other hardware models as well as in environments where the application and operating system code may be controlled.

Memory Access

Disclosed herein are systems and methods that may be employed to facilitate communication between two or more separate processing objects in communication in a distributed processing environment having distributed memory, e.g., such as two or more separate processing objects in communication across a switch fabric, virtual distributed interconnect, network media, network switch, fibre channel, etc. Using the disclosed methods and systems, remote access to the operating system memory of one or more first processing objects may be effectively provided to one or more second processing objects on a transactional basis by using a tag or identifier to label information exchanged between the respective first and second processing objects. In this regard, a first processing object may be in communication with a second processing object resident on the same processing engine or module, and/or resident on a different processing engines or modules. In this regard, the disclosed systems and methods may be implemented to facilitate communication and memory access between any two or more processing objects having disparate memory spaces, whether or not the disparate memory space exist on the same processing entity, or exist on different processing entities. Further, it will be understood that two or more processing objects may be in communication across any medium suitable for inter-processing object communications including, but not limited to, metal or other electrically conductive materials, optical fiber, wireless (e.g. including via satellite communication), combinations thereof, etc.

Included among the environments in which the disclosed systems and methods may be advantageously practiced are those environment where there are multiple separate processing objects and/or entities communicating with each other that each lack knowledge and direct access to the memory structure of the other processing objects/entities. The disclosed systems and methods may also be advantageously implemented in environments where there are multiple data streams between multiple entities and/or where synchronous ordering of fabric messages between any two such entities is not desirable or guaranteed (e.g., due to message prioritization, caching algorithms and other performance optimizations that may be implemented that nullify serial completion ordering assumptions). In this regard, protocols that distribute loads by forced ordering of messages between multiple entities may undermine other optimization strategies employed in a distributed processing/distributed memory-based architecture (e.g., parallelism of I/O requests by a general purpose operating system and parallel responses to these I/O requests by more than one storage operating system).

In one embodiment, remote access to a first processing object (e.g., operating system memory of an application processing engine or other processing entity) may be effectively provided to a second processing object (e.g. running on a storage processing engine or other processing entity) on a transactional basis by using a tag or identifier to label individual data packets exchanged between the two processing objects in a distributed processing/distributed memory environment, such as may be exchanged across a distributed interconnect (e.g., switch fabric, virtual distributed interconnect, etc.). In the practice of the disclosed systems and methods, an identifier may be a tag that is suitable for inclusion in inter-processing object messages, and that may be used to represent particular location/s in the memory associated with a first processing object, for example, that provides for the identification of a targeted location in the memory (e.g., buffer) associated with the first processing object for placement of the data contained in the data packets. Examples of suitable identifiers or tags include, but are not limited to, memory address pointers, indexes or any other mechanism that provides for the identification of a targeted location in the memory, e.g., distributed protocol calls such as remote procedure call or function call, etc.

Use of the disclosed tags or identifiers to provide remote memory access may be advantageously implemented to eliminate buffer copies (e.g., in the read I/O path between a storage operating system and an application operating system), thus reducing processor cycle consumption that would otherwise be required for purposes of creating and processing such buffer copies, regardless of disordered message conditions that may exist (e.g., when multiple storage operating systems and/or application operating systems communicate across a distributed interconnect). In some embodiments, this results in reduced operating system processor consumption when compared to conventional switch fabric-based message passing system architectures. By reducing processor consumption, a substantial amount of processing resources may be freed up to be used for other purposes (e.g., higher levels of processing by a target application).

Examples of types of distributed interconnects that may be employed in the practice of the disclosed systems and methods include, but are not limited to, switch fabrics and virtual distributed interconnects such as described in co-pending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” and in U.S. patent application Ser. No. 10/003,683 filed on Nov. 2, 2001 which is entitled “SYSTEMS AND METHODS FOR USING DISTRIBUTED INTERCONNECTS IN INFORMATION MANAGEMENT ENVIRONMENTS”, each of which is incorporated herein by reference. In this regard, configurations of separate processing engines, such as those of FIG. 1A or 2, may be distributively interconnected across a network, such as a LAN or WAN (e.g., using a distributed and deterministic system BIOS and/or operating system) to create a virtual distributed interconnect backplane between individual subsystem components across the network that may, for example, be configured to operate together in a deterministic manner. This may be achieved, for example, using embodiments of the disclosed systems and methods in combination with technologies such as wavelength division multiplexing (“WDM”) or dense wavelength division multiplexing (“DWDM”) and optical interconnect technology (e.g., in conjunction with optic/optic interface-based systems), INFINIBAND, LIGHTNING I/O or other technologies. In such an embodiment, one or more processing functionalities may be physically remote from one or more other processing functionalities (e.g., located in separate chassis, located in separate buildings, located in separate cities/countries, etc.). Advantageously such a configuration may be used, for example, to allow separate processing engines to be physically remote from each other and/or to be operated by two or more entities (e.g., two or more different service providers) that are different or external in relation to each other. In an alternate embodiment however, processing functionalities may be located in a common local facility if so desired.

In one embodiment, a distributed RMA protocol (DRP) may be employed to communicate processing engine memory address information between individual processing engines coupled together by a distributed interconnect. Such a distributed RMA protocol (DRP) may be employed to eliminate the need for buffer copies in an inter-processing data path by virtue of the fact that it enables a second processing engine to deliver data directly to a particular memory address of a first processing engine. In one example, a specified destination memory address of a first processing engine may be communicated by the first processing engine to the second processing engine as part of a request for data, thus enabling the second processing engine to respond by delivering the requested data directly to the specified destination memory address, where it may be accessed by a processing object (e.g., operating system) running on the first processing engine.

A distributed RMA protocol may be implemented in any manner suitable for communicating memory address information between individual processing engines, but in one embodiment may be implemented in conjunction with a standardized internal protocol that may be, for example, any protocol that allows the initiator of a read message to encapsulate physical location (e.g., master fabric protocol (MFP)), such as described elsewhere herein in relation to switch fabrics. As previously described, such an internal protocol may include a system of message classes, or types, where the different classes may independently include fields or layers that are utilized to identify the destination processor engine or processor module for communication, control, or data messages provided to the switch fabric along with information pertinent to the corresponding message class. Although previously described herein in relation to switch fabric implementations, such a standardized internal protocol may also be implemented with other interconnect methodologies (e.g., other types of distributed interconnects described herein).

By employing a master fabric protocol that allows arbitrary extensions, a distributed RMA protocol may be implemented using header extensions (i.e., extended header) of the master fabric protocol to encapsulate the distributed RMA protocol which allows incorporation (“piggybacking”) of RMA tags into existing messages. The master fabric protocol may be employed to deliver the distributed RMA protocol header extensions to a processing entity (e.g., processing engine or module) that understands them.

In one embodiment, a distributed RMA protocol message (e.g., request for data) may be sent across a distributed interconnect by a first processing object (e.g., an application operating system running on an application processing engine) to a second processing object (e.g., storage operating system running on a storage processing engine). In this regard, a distributed RMA protocol request message may be characterized as any message that includes RMA information. For example, in one embodiment, a distributed RMA protocol request message may include a specific distributed RMA protocol tag somewhere in the request message that includes information identifying or otherwise representing a memory address (e.g., designated physical address) associated with the first processing object (e.g., application operating system) designated for receiving requested data from the second processing object (e.g., running on a storage processing engine). Such an RMA tag may be included as a header field in the request message, or may be included as a parameter or parameter list anywhere in the request message.

In response to the received request from the first processing object (e.g., application operating system), the second processing object (e.g., running on the storage processing engine) may send the requested data to the second processing object across the distributed interconnect, with one or more components of the second processing object configured to ensure that the distributed RMA tag or an identifier based on the distributed RMA tag is returned to the processing object (e.g., along with packets of requested data). The response message may be sent as a specific distributed RMA protocol response message class or type (i.e., with RMA tag in message header as part of the message definition), or may be sent as another class or type of message (e.g., having an RMA tag embedded within part of the message header space). On arrival, one or more components of the first processing object may be configured to recognize the distributed RMA protocol message and to use the memory address information contained in the RMA tag as a guide to deliver the requested data directly to the designated memory address associated with the first processing object. This process may be hardware-based, software-based, or a combination thereof.

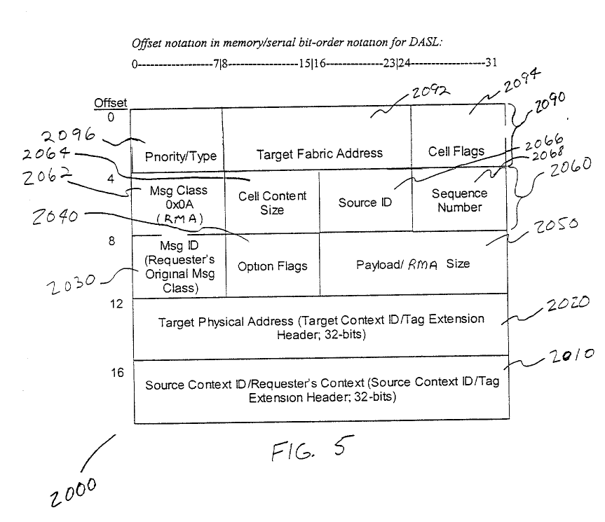

FIG. 5 illustrates one exemplary embodiment of a fixed protocol data unit (“PDU”) header 2000 that may be utilized to implement a distributed RMA protocol response message class in a switch fabric environment, such as with the IBM PRIZMA-E switch fabric-based systems described and illustrated elsewhere herein. Such a PDU header 2000 may be characterized as being a media access control (“MAC”) layer header, for example, at the same layer as an Ethernet layer. Although FIG. 5 illustrates one exemplary PDU embodiment that may be employed in a switch fabric implementation, it will be understood with benefit of this disclosure that the disclosed systems and methods may be implemented, for example, using any packet methodology (e.g., any PDU associated with WAN protocol, IEEE protocol, ANSI protocol, etc.) having a header or other field that is suitable for communication from a first processing object to a second processing object, and for identifying itself to the second processing object as a distributed RMA protocol-based packet having one or more fields contained therein that contain RMA-based information. Thus, for example, the disclosed systems and methods may be implemented using an Ethernet packet having one or more headers.

Furthermore, it will be understood that the particular fields illustrated and described in relation to FIG. 5 are exemplary only and that a greater or fewer number of fields may be present in a given header as desired to fit a particular application (e.g., not all illustrated fields need be present, additional fields to those illustrated may be present, fields different from those illustrated may be present, etc.). It will also be understood that a distributed RMA request message may be implemented with a similar message class header format, or alternatively may be implemented employing other types of message class header formats.

FIG. 5 illustrates PDU header 2000 having a size of 20 bytes minimum, and employing two PDU header extension fields 2010 and 2020. In FIG. 5, structures are shown in a lowest order to highest order memory address fashion using ‘offset notation’ to describe a field's position relative to its base address in memory, e.g., a notation synonymous with the serial bit order in which PDU/Cell data is transferred to from a Prizma-E switch fabric on its serial interface (DASL). In this exemplary embodiment, a first header extension field 2020 may be a Target Context Tag field which contains the target physical address on a requesting first processing object (e.g., application operating system running on application processing engine) for which the fabric is to initiate remote memory access. The second header extension field 2010 may contain Source Context ID/Tag information for the requesting first processing object so that the requesting first processing object may correlate requested information that is received from a responding second processing object (e.g., storage operating system running on storage processing engine) with a particular original request event generated by the first processing object.

Still referring to FIG. 5, distributed RMA protocol response message PDU header 2000 may include a global common cell (“GCH”) header 2090 that may contain, for example, cell information such as cell priority/type field 2096 such as data or control type and priority (e.g., critical, high, medium, low, etc.). In other embodiments, field 2096 may be implemented, for example, using a similar IP protocol field. Also shown in FIG. 5 is target/destination address field 2092 that may be, for example, a bit map of target port(s) and for switch fabric hardware. In other embodiments, field 2092 may be implemented, for example, using Ethernet MAC address. GCH header 2090 may also contain cell flag field 2094 that contains flags identifying cell PDU structure (e.g., that may indicate whether a given cell is a control or data cell, where a given cell falls within a PDU, how many header extensions are employed, dynamic header extension information, etc.

As shown in FIG. 5, a common control cell header (“CCH”) 2060 may also be provided that includes a message class field 2062 indicating the particular message class/protocol (e.g., RMA message class) of the PDU. In other embodiments, field 2062 may be implemented, for example, using a similar protocol/type header in 802.3 Ethernet. A source ID field 2066 may be employed to identify the source fabric node by including a compressed source address. In other embodiments, field 2066 may be implemented, for example, using a similar Ethernet MAC source address field. A cell content size field 2064 may be provided that to denote the number of valid content (i.e. non-header) bytes within the current cell so as to indicate to a receiving RMA engine the number of valid content bytes to be mastered into subsystem RAM buffers that may be, for example, rounded up to the next highest multiple of 4 bytes. A sequence number field 2068 may be employed, for example, to provide sequence number of cells so that they may be reassembled back into a compute PDU by higher level protocols. In other embodiments, field 2066 may be implemented, for example, using a similar ID sequence number field.

Still referring to FIG. 5, RMA Message ID field 2030 of PDU header 2000 may contain the original requesting first processing object message class value of the PDU that initiated a distributed RMA protocol response message. This value helps a receiving Fabric RMA engine determine which source initiated the distributed RMA protocol message activity for potential notification. Option flags 2040 may employ TARGET CONTEXT TAGGED and SOURCE CONTEXT TAGGED bits set indicating the presence of the Target Physical Address/Target Context ID and Context/Source Context ID header extension fields 2020 and 2010. Other bit values may be set additionally as needed. Payload/RMA Size field 2050 may be employed to contain the size of the entire PDU (msg) payload, in bytes, that is to be placed into the memory of the receiving processing object using distributed RMA protocol. Target Context ID/Target Physical Address field 2020 may contain the physical memory address where the fabric RMA engine (e.g., AOS fabric RMA engine) is to place the data payload of the distributed RMA protocol response message. This value may be passed to the second processing object, for example, in a PDU header of a preceding distributed RMA protocol request message; usually in a Target Context ID header field. Source Context ID/Requester's Context field 2010 may contain any correlating information (e.g., virtual memory address, buffer pointer, structure pointer, etc.) that the first processing object needs to efficiently correlate the incoming distributed RMA protocol response message data with the original distributed RMA protocol request message. These fields may be of any suitable size, for example, they may be either 32- or 64-bits in size.

Still referring to the exemplary embodiment of FIG. 5, when a distributed RMA protocol response message PDU header 2000 is received by a fabric RMA engine (e.g., AOS fabric RMA engine), the receiving fabric RMA engine may perform the designated remote memory access operation by placing the response message PDU header in a Receive Buffer Descriptor and then setting the Buffer Descriptor Flags to indicate completion of the receipt of the distributed RMA protocol response operation. One or more functional restrictions may be applied to distributed RMA protocol message operations, e.g., the receiving fabric RMA engine may be configured to always place the PDU header portion of a distributed RMA protocol response message PDU header 2000 into the PDU Payload field of a Buffer Descriptor it is accessing to process distributed RMA protocol PDU reception. In such a case, it may be desirable for the receiving processing engine to setup a specific receive queue for the distributed RMA protocol response Message Class.

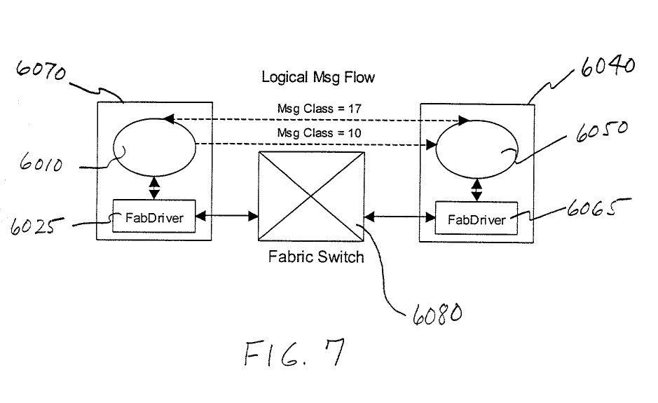

One example of remote memory access using the exemplary distributed RMA protocol response message PDU header 2000 of FIG. 5 is illustrated and described in Example 2 and FIG. 7. It will be understood that FIG. 5 is exemplary only, and that any other suitable protocol configuration may be employed. Furthermore, although 32 bit header extension configuration is illustrated in FIG. 5, it will be understood that other configurations may be employed as well, e.g., 64 bit, etc.

As previously described, the disclosed systems and methods may be implemented to facilitate communication and memory access between any two processing objects having disparate memory spaces, whether or not the disparate memory space exist on the same processing entity, or exist on different processing entities. However, in one embodiment, the disclosed systems and methods may be implemented to facilitate communication between two or more processing objects in an information management/delivery environment.

Examples of just a few of the many types of information delivery environments and/or information management system configurations with which the disclosed methods and systems may be advantageously employed are described in co-pending U.S. patent application Ser. No. 09/797,413 filed on Mar. 1, 2001 which is entitled NETWORK CONNECTED COMPUTING SYSTEM; in co-pending U.S. patent application Ser. No. 09/797,200 filed on Mar. 1, 2001 which is entitled SYSTEMS AND METHODS FOR THE DETERMINISTIC MANAGEMENT OF INFORMATION; and in co-pending U.S. patent application Ser. No. 09/879,810 filed on Jun. 12, 2001 which is entitled SYSTEMS AND METHODS FOR PROVIDING DIFFERENTIATED SERVICE IN INFORMATION MANAGEMENT ENVIRONMENTS; and in U.S. patent application Ser. No. 10/003,683 filed on Nov. 2, 2001 which is entitled “SYSTEMS AND METHODS FOR USING DISTRIBUTED INTERCONNECTS IN INFORMATION MANAGEMENT ENVIRONMENTS”; U.S. provisional patent application No. 60/353,104, filed Jan. 30, 2002, and entitled “SYSTEMS AND METHODS FOR MANAGING RESOURCE UTILIZATION IN INFORMATION MANAGEMENT ENVIRONMENTS,” by Richter et. al.; U.S. patent application Ser. No. 10/060,940, filed Jan. 30, 2002, and entitled “SYSTEMS AND METHODS FOR RESOURCE UTILIZATION ANALYSIS IN INFORMATION MANAGEMENT ENVIRONMENTS,” by Jackson et al.; U.S. provisional patent application serial No. 60/353,641, filed Jan. 31, 2002, and entitled “SYSTEM AND METHODS FOR READ/WRITE I/O OPTIMIZATION IN INFORMATION MANAGEMENT ENVIRONMENTS,” by Richter et al., each of the foregoing applications being incorporated herein by reference. In one embodiment, the disclosed systems and methods may be implemented in network connected computing systems that may be employed to manage the delivery of content across a network that utilizes computing systems such as servers, switches and/or routers.

The forgoing incorporated references describe and illustrate examples of information management system architectures that employ individual modular processing engines configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources, I/O resources, etc.) to be deployed by sharing or reassignment in order to optimize information management (e.g., to maximize acceleration of content delivery) by the information management system. In such architectures, policy enhancement/enforcement may be optimized by placing intelligence in each individual modular processing engine. Such information management system architectures may be construed in one embodiment to implement a switch based computing system, and may further be characterized to implement an asymmetric multiprocessor system configured in a staged pipeline manner.

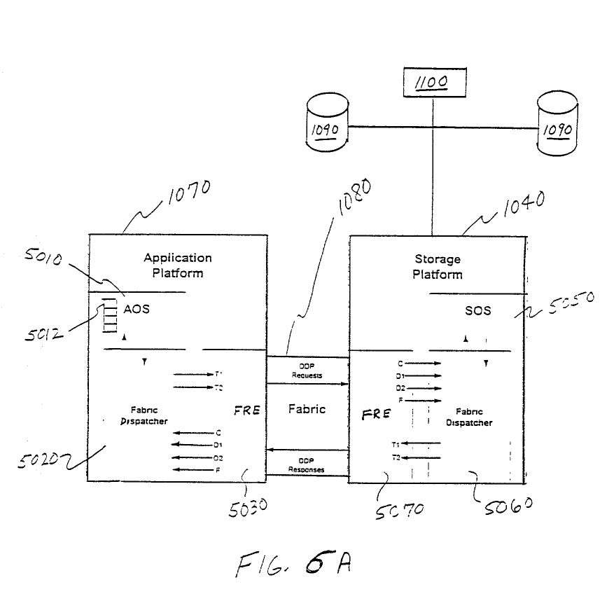

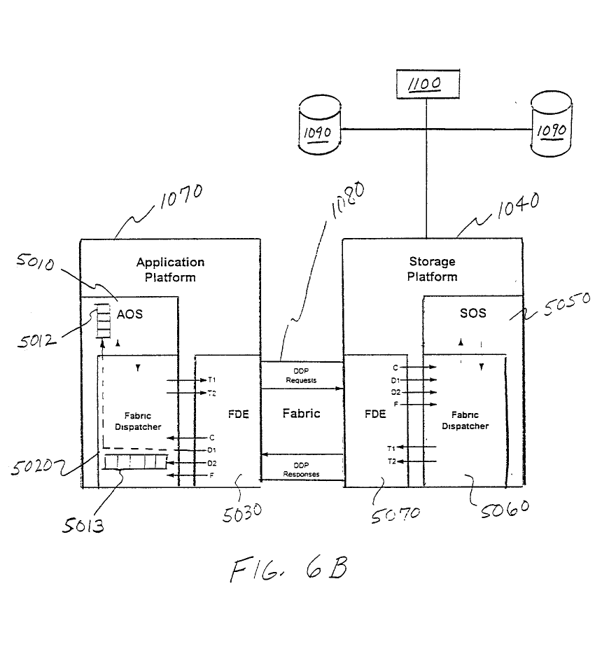

FIG. 6A illustrates one exemplary embodiment of the disclosed distributed RMA message passing architecture, for example, as it may be implemented in an information management environment such as the content delivery system embodiments illustrated and described in relation to FIGS. 1A, 1C-1F, and FIG. 2. In this regard, FIG. 6A illustrates application processing engine 1070 communicatively coupled to storage processing engine 1040 via a distributive interconnection 1080. Storage processing engine 1040 is shown coupled to content sources 1090 and/or 1100 which may be, for example, those content sources described in relation of FIG. 1A. Not shown in FIG. 6A are one or more other processing engines that may be present and communicatively coupled to application processing engine 1070 and storage processing engine 1040, for example in a manner as described in relation to FIGS. 1A, 1C-1F, and FIG. 2.

Examples of features and environments with which storage management engine 1040 may be implemented if desired, include those found described in U.S. patent application Ser. No. 09/797,198, entitled “SYSTEMS AND METHODS FOR MANAGEMENT OF MEMORY” by Qiu et. al; U.S. patent application Ser. No. 09/797,201, filed Mar. 1, 2001 and entitled “SYSTEMS AND METHODS FOR MANAGEMENT OF MEMORY IN INFORMATION DELIVERY ENVIRONMENTS” by Qiu et. al; U.S. patent application Ser. No. 09/947,869 filed on Sep. 6, 2001 which is entitled “SYSTEMS AND METHODS FOR RESOURCE MANAGEMENT IN INFORMATION STORAGE ENVIRONMENTS,” by Qiu et al.; and U.S. patent application Ser. No. 10/003,728 filed on Nov. 2, 2001, which is entitled “SYSTEMS AND METHODS FOR INTELLIGENT INFORMATION RETRIEVAL AND DELIVERY IN AN INFORMATION MANAGEMENT ENVIRONMENT,” by Johnson, et al., the disclosures of each of which are incorporated herein by reference.

FIG. 6A illustrates one embodiment of the disclosed RMA message passing architecture as it may be implemented with an application processing engine and a storage processing engine (e.g. to accomplish storage system I/O operations). However, it will be understood that other embodiments are possible including, but not limited to, embodiments in which other types of processing objects, processing engines and/or other combinations of processing objects and/or engines may communicate with each other across a distributed interconnect using the disclosed RMA message passing architecture, e.g., two or more application processing engines communicating with each other across a distributed interconnect, an application processing engine communicating with a network processing engine across a distributed interconnect, a network processing engine communicating with an application processing engine across a distributed interconnect, an application processing engine communicating with a file system object (e.g., file system of network attached storage, network filer, etc.) to accomplish a file I/O operations across a distributed interconnect, two or more of any other types of processing engines of an information management system (such as described elsewhere herein) communicating across a distributed interconnect, etc.

Furthermore, it will be understood that the disclosed systems and methods may be implemented to facilitate communication between two or more processing objects in any processing environment involving direct placement of data or other information into a memory associated with at least one of the processing objects (e.g., into a specific memory location of a memory associated with a processing object). For example, the disclosed systems and methods may be implemented in any distributed processing/distributed memory environment to allow a first processing engine and/or processing object to modify memory of a second processing engine and/or object, to allow modification of the memory of two or more processing engines and/or processing objects to be the same, etc. Specific examples of possible implementations include, but are not limited to, implementation involving two or more communicating application processing engines, two or more communicating drivers performing transport operations between application processing engines, two or more communicating kernels, etc.

In the exemplary embodiment of FIG. 6A, application processing engine 1070 includes an application operating system 5010, AOS fabric dispatcher 5020, and an application fabric RMA engine 5030. Storage processing engine 1040 includes a storage operating system 5050, a SOS fabric dispatcher 5060 and a storage fabric RMA engine 5070. Application operating system 5010 and storage operating system 5050 may be implemented in any manner suitable for imparting the respective application processing and storage processing capabilities to processing engines 1070 and 1040 as described elsewhere herein. AOS fabric dispatcher 5020 and SOS fabric dispatcher 5060 may be implemented (e.g., as device drivers or as permanent memory) that communicate with fabric RMA engines 5030 and 5070 in a manner as described further herein.

In one example, application operating system 5010 (including AOS fabric dispatcher 5020) may be implemented as software running on a suitable processor, such as the INTEL PENTIUM III processor of an application processing module 1001 described herein in relation to FIGS. 1C-1F. Likewise, storage operating system 5050 (including SOS fabric dispatcher 5060) may be implemented as software running on a suitable processor, such as the POWER PC 7450 processor of a storage processing module 1003 described herein in relation to FIGS. 1C-1F. In other embodiments, application operating system 5010 and/or storage operating system 5050 may be implemented, for example, as software running on independent, industry-standard computers connected by a distributed interconnect such as described elsewhere herein, etc. In yet other embodiments, an AOS fabric dispatcher and/or a SOS fabric dispatcher may be implemented separately from a respective application operating system and/or storage operating system, e.g. as a separate processing object running on the same processor as the respective operating system, or as a separate processing object running on a different processor from the respective operating system. When implemented separately from an operating system, a fabric dispatcher may be configured to operate with a conventional operating system, e.g., such as Linux, FreeBSd, WindowsNT, etc.

Application fabric RMA engine 5030 and storage fabric RMA engine 5070 may also be implemented in any suitable manner, for example, as fabric interfaces 34 such as illustrated and described herein in relation to FIG. 4. In one exemplary embodiment, fabric RMA engine 5030 and storage fabric RMA engine 5070 may each be implemented as software functionalities that are implemented on a hardware FPGA device such as illustrated and described herein in relation to FIGS. 1C-1F. For example, application fabric RMA engine 5030 may be implemented as a medium access controller (MAC) by one or more of the FPGA of processor modules 1001, and storage fabric RMA engine 5070 may be implemented as a medium access controller by one or more of the FPGA of processor modules 1003. It will be understood, however, that fabric RMA engines 5030 and/or 5070 may be implemented in any other manner suitable for accomplishing the fabric RMA engine capabilities described herein, for example, as software running on an intelligent fabric interface controller, etc. A few examples of such fabric RMA engine capabilities include, but are not limited to, accepting a data packet, interpreting/recognizing the nature of the contents of the packet, and directly delivering the data in the packet to a specified memory location.

Using the exemplary embodiment of FIG. 6A, distributed RMA protocol messages may be exchanged between application operating system 5010 and storage operating system 5050 in conjunction with fabric dispatchers 5020 and 5060 and fabric RMA engines 5030 and 5070. In this embodiment, AOS fabric dispatcher 5020 is implemented as a part of application operating system 5010 and is present to exchange distributed RMA protocol messages (e.g., requests for data and responses that include the requested data) with SOS fabric dispatcher 5060 implemented as part of storage operating system 5050. AOS fabric dispatcher 5020 may be employed to manage (e.g., preallocate) AOS buffers 5012 for placement of requested data received across distributed interconnect 1080 via AOS fabric RMA engine 5030. AOS buffers 5012 are shown in FIG. 6A as being within application operating system 5010. It will be understood that such buffers may be implemented in any suitable location on application operating system 1070, for example, by a filesystem module that is a direct client of AOS fabric dispatcher 5020.

Distributed RMA protocol messages sent by application operating system 5010 to storage operating system 5050 may include distributed RMA protocol header extensions that specify the location of AOS buffers 5012 for delivery of requested data. Upon receiving distributed RMA protocol messages from AOS fabric dispatcher 5020, SOS fabric dispatcher 5060 then forwards these messages to storage operating system 5050 for processing. Similarly, AOS fabric dispatcher 5020 receives distributed RMA protocol messages from SOS fabric dispatcher 5060, and forwards them to application operating system 5010 for processing. When responding to a request for stored data from application operating system 5010, storage operating system 5050 ensures that the distributed RMA protocol header extension is returned along with each data packet. On arrival at application processing engine 1070, AOS fabric RMA engine 5030 recognizes the data class of the distributed RMA protocol return message, and uses the returned distributed RMA protocol header extension to deliver the requested file data directly to the specified AOS buffers 5012.

As an example, a distributed RMA protocol message (e.g., request for stored data) may be sent across distributed interconnect 1080 (e.g., a switch fabric) from application operating system 5010 running on an application processing engine 1070 to storage operating system 5050 running on storage processing engine 1040 as a result of an application operating system read request. In addition to the identity of the requested data (e.g. data blocks) the distributed RMA protocol request message may include an associated scatter-gather list of AOS buffer addresses into which the requested data received from storage processing engine 1040 is to be directly delivered.

In the illustrated embodiment, the distributed RMA protocol request message is sent by application operating system 5010 through AOS fabric dispatcher 5020, which assigns or pre-allocates address/es of the AOS buffers 5012 into which the requested data is to be directly delivered by AOS fabric RMA engine 5030. The distributed RMA protocol request message is then communicated to AOS fabric RMA engine 5030 and passed on via distributed interconnect 1080. This may be accomplished using the embodiment of FIG. 6A as follows. When AOS fabric dispatcher 5020 receives a read I/O request from application operating system 5010, it may create a distributed RMA protocol header extension containing, for example, the physical addresses and extents of the target AOS buffers 5012 (e.g., a single buffer or several buffers to be used for the data of the entire data packet). The distributed RMA protocol request message is then forwarded to storage processing engine 1040 through SOS fabric RMA engine 5070 and distributed interconnect 1080. If desired, two or more AOS transmit queues (e.g., T1, T2, etc.) may be optionally provided, for example, to prioritize transmittal of individual distributed RMA protocol request messages relative to each other, e.g., for purposes of implementing differentiated services as described elsewhere herein.

On arrival at storage processing engine 1040, SOS fabric RMA engine 5070 recognizes the data class of the distributed RMA protocol request message and forwards the request for data to storage operating system 5050, maintaining the distributed RMA protocol header extension associated with the distributed RMA protocol request message received from application processing engine 1070. As illustrated in FIG. 6A, two or more SOS message class specific receive queues may be optionally provided (e.g., D1, D2, etc.), for example, to prioritize the processing of individual distributed RMA protocol request messages relative to each other, e.g., for purposes of implementing differentiated services as described elsewhere herein. Alternatively or additionally, at least one of such multiple SOS message class specific receive queues may be designated for use as a distributed RMA protocol receive queue and at least one of such multiple SOS message class specific receive queues may be designated for use as a non-distributed RMA protocol receive queue, for example, in a manner similar to that described below in reference to application processing engine 1070. Also illustrated in FIG. 6A are SOS control queue (C) that may be provided for high-priority control messages, and SOS final queue (F) that may be provided for all other messages not falling into other provided queues, e.g., queues C, D1, D2, etc. It will be understood that the number and types of queues may vary from those exemplary queues described herein, e.g., as desired or necessary for a given implementation.

In response to the request for data, storage operating system 5050 retrieves the requested data from one or more content sources 1090 and/or 1100, and sends the requested data back across distributed interconnect to application processing engine 1070 along with the original unchanged distributed RMA protocol header extension. In this regard, the retrieved data is sent back through SOS fabric dispatcher 5060 and SOS fabric RMA engine 5070 that act to transmit the data and distributed RMA protocol header across distributed interconnect 1080 to application processing engine 1070. In a manner similar to that described for application processing engine 1070, two or more SOS transmit queues (e.g., T1, T2, etc.) may be optionally provided, for example, to prioritize transmittal of individual distributed RMA protocol response messages relative to each other.

When the retrieved data arrives at application processing engine 1070, AOS fabric RMA engine 5030 recognizes the data class of the distributed RMA protocol response message, and uses the distributed RMA protocol header extension to deliver the requested data directly to the AOS buffer/s (e.g., physical address) specified in the returned distributed RMA protocol header extension. Referring to the embodiment of FIG. 6A, AOS fabric RMA engine 5030 may be implemented so that it is capable of not only reading the entire MFP header to get the message class of the data packet for all types of incoming traffic, but also capable of reading the distributed RMA protocol header of each incoming message. As so implemented, AOS fabric RMA engine 5030 may recognize a distributed RMA protocol response message sent by storage processing engine 1040 and parse its distributed RMA protocol header for physical address information, e.g., rather than retrieving it from a receive descriptor. In one exemplary embodiment, a pre-read size of about of 32 bytes or more may be employed for messages having several fragments.

AOS fabric RMA engine 5030 may then extract the target address information from the distributed RMA protocol header and transfer the retrieved file data directly into the target buffers 5012 specified by application operating system 5010 in its original request for data. In a manner similar to that described in relation to storage processing engine 1040, two or more AOS message class specific receive queues may be optionally provided (e.g., D1, D2, etc.), for example, to prioritize the processing of individual distributed RMA protocol response messages relative to each other. In such an implementation it is possible to assign incoming distributed RMA protocol data to AOS queues based on priority, e.g., for purposes of implementing differentiated services as described elsewhere herein. Similar to storage processing engine 1040, AOS control queue (C) may be provided for high-priority control messages, and AOS final queue (F) may be provided for all other messages not falling into other provided queues, e.g., queues C, D1, D2, etc.

In a multiple AOS message class specific receive queue environment, at least one of the multiple AOS message specific receive queues may be additionally or alternatively dedicated for use as a distributed RMA protocol receive queue, although this feature is optional. One example of an embodiment employing a dedicated distributed RMA protocol receive queue D1 is illustrated in FIG. 6B. As with FIG. 6A, FIG. 6B represents just one exemplary embodiment and it will be understood that other embodiments are possible including, but not limited to, embodiments in which other types of processing objects, processing engines and/or other combinations of processing objects and/or engines may communicate with each other across a distributed interconnect using the disclosed RMA message passing architecture, e.g., two or more application processing engines communicating with each other across a distributed interconnect, two or more of any other types of processing engines of an information management system such as described elsewhere herein, etc.

When a dedicated distributed RMA protocol receive queue is provided as illustrated in FIG. 6B, AOS fabric RMA engine 5030 may then associate a given incoming response with the next available receive descriptor on the dedicated distributed RMA protocol receive queue and notify AOS fabric dispatcher 5020 of its arrival. Further, when a dedicated distributed RMA protocol receive queue is employed, the descriptors on the receive queue may be implemented so that they do not have scatter-gather lists associated with them as other queues may. Instead, association may be established by AOS fabric RMA engine 5030 by writing the buffer physical addresses and extents from the distributed RMA protocol header into the next available receive descriptor, after transferring the file data to those addresses. AOS fabric dispatcher 5020 and AOS fabric RMA engine 5030 may be implemented so that they cooperate in the optional configuration of dedicated queues.

If so desired, distributed RMA protocol may be optionally implemented by an information management system on a request by request basis. This may be desirable, for example, in a case where an AOS fabric dispatcher determines it to be the most efficient method for a particular transaction. For example, AOS fabric dispatcher 5020 may be capable of determining whether or not a particular request issued by application operating system 5010 is to be handled using distributed RMA protocol with the requested information placed into specified AOS buffers 5012. In such an implementation, AOS fabric dispatcher 5020 may be aware of which requests (e.g., requests from particular users, requests from particular classes of users, particular types of requests, combinations thereof, etc.) are to be handled using distributed RMA protocol. AOS fabric dispatcher 5020 may be so informed using any suitable manner, for example, by previous negotiation configuration of the system for all subsequent transactions, by direct request from a client of the AOS fabric dispatcher for a single transaction, by sensing that the size of the data block to be returned warrants distributed RMA, etc. Based on this knowledge, AOS fabric dispatcher 5020 may assign a message class to each request that is reflective of whether or not the requested data is to be handled using distributed RMA protocol. Thus, distributed RMA protocol data requests and non-distributed RMA protocol data requests may be multiplexed together across distributed interconnect 1080 to storage processing engine 1040 and responses thereto returned in similar multiplexed fashion. Upon receipt of the requested information with the returned header information, AOS fabric RMA engine 5030 may be employed to recognize the assigned message class of the incoming data (i.e., as originally assigned by AOS fabric dispatcher 5020), and to demultiplex the responses by treating the disposition of the returned data based on recognized message classes.

For example, in one exemplary embodiment illustrated in FIG. 6B, different AOS message class receive queues may be provided for each type or class of message handling (e.g., distributed RMA protocol message classes versus non-distributed RMA protocol classes). In such an embodiment, AOS fabric RMA engine 5030 may be employed to recognize the message class of each incoming data packet and to place the data associated with a given packet into a particular AOS receive queue based on the message class of the data packet. Data placed into an AOS receive queue for distributed RMA protocol messages (e.g., queue D1 of FIG. 6B) is delivered by AOS fabric RMA engine 5030 to AOS buffers 5012 according to the specified AOS buffer address contained in the distributed RMA protocol header. Data placed into a non-distributed RMA protocol queue (e.g., queue D2 of FIG. 6B) is delivered by AOS fabric RMA engine 5030 into arbitrary receive buffers allocated in fabric dispatcher local memory 5013 by AOS fabric dispatcher 5020. In this way, the returned data is de-multiplexed by AOS fabric RMA engine 5030.

In one embodiment, selective use of distributed RMA protocol may be employed on a request-by-request basis as part of a differentiated service implementation, e.g., using distributed RMA protocol to process higher priority requests or requests from higher priority users, using distributed RMA protocol to process types of requests that consume greater memory and/or processing resources, etc. Additionally or alternatively, it is also possible to implement differentiated service features by prioritizing individual distributed RMA protocol messages (e.g., data requests and/or responses) relative to each other, for example, using multiple transmit queues and/or receive queues as described and illustrated in relation to the exemplary embodiment of FIG. 6A, e.g., assigning request and/or response messages associated with a particular type of request and/or a request from a particular user to a higher priority receive or transmit queue. Examples of types of differentiated services (including differentiated business services and/or differentiated information services), as well as systems and methods with which distributed RMA protocol may be implemented to provide such differentiated services, may be found in copending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” which is incorporated herein by reference.

In another embodiment of the disclosed systems and methods, multiple packets of data may be assembled or combined into a single combination data packet that is transmitted across a distributed interconnect from one processing engine to another. In such an embodiment, the processing burden for handling such a single combination data packet is much less than the combined processing burden presented by separately processing each of the multiple data packet constituents of the combination data packet.

For example, referring to the exemplary embodiment of FIG. 6A, application operating system 5010 may communicate a read I/O request to AOS fabric dispatcher 5020. Upon receipt of the read I/O request, AOS fabric dispatcher 5020 may create a single distributed RMA protocol request message that contains the identity of multiple elements of requested data (e.g., four 1024-octet blocks of non-physically-contiguous data) and a distributed RMA protocol header extension array containing the physical addresses and extents of the target AOS buffers 5012 for placement of each element of the requested data. The distributed RMA protocol request message may also contain information concerning the desired ordering for receipt of each of the elements of requested data. The distributed RMA protocol request message is then forwarded to storage processing engine 1070 through SOS fabric RMA engine 5070 and distributed interconnect 1080.

In one embodiment, multiple data elements may represent separate data blocks of a filesystem that comprise a page of memory in the AOS. For efficiency, the AOS filesystem may choose to represent them to the SOS as the data blocks that it understands, but may write these blocks to AOS memory as a complete physical page of memory. It will be understood that implementation may depend on usage of specific optimization techniques by a filesystem and may be optional.

On arrival at storage processing engine 1040, SOS fabric RMA engine 5070 recognizes the data class of the distributed RMA protocol request message and forwards the request for data to storage operating system 5050, maintaining the distributed RMA protocol header extension array associated with the distributed RMA protocol request message received from application processing engine 1070. In response to the request, storage operating system 5050 retrieves the requested multiple data elements (e.g., elements corresponding to all or part of a file as may be determined by maximum DRP transmit size) from storage (e.g., from content source/s and/or cache). To optimize storage processing engine performance, it is possible that elements of requested data retrieved from cache may be retrieved quicker and out of order with respect to elements of data retrieved from one or more content sources.

In response to a RMA protocol request message (or in response to a combination of multiple RMA protocol request messages), storage operating system 5050 may retrieve the requested multiple data elements and assemble them into a single combined data packet. Storage operating system 5050 may retrieve the requested multiple data elements as contiguous data for placement into such a data packet. However, in one embodiment it is possible to implement an optional SOS file system on storage processing engine 1040 to enable storage operating system 5050 to also retrieve requested data elements as noncontiguous data for placement into a data packet. In another optional embodiment, storage operating system 5050 may also order individual data elements according to any element ordering information contained in the distributed RMA protocol request message/s. Storage operating system 5050 then sends the requested multiple data elements back across distributed interconnect to application processing engine 1070 through SOS fabric dispatcher 5060 and SOS fabric RMA engine 5070.

Although described above in relation to a single data packet, it will be understood that in yet another optional embodiment, storage operating system 5050 may retrieve the requested multiple data elements, assemble them into multiple data packets (e.g., each multiple data element contained in a respective one of said multiple data packets, respective subgroup of said multiple data packets, etc.) and then send the multiple data packets back across distributed interconnect to application processing engine 1070 through SOS fabric dispatcher 5060 and SOS fabric RMA engine 5070. In the latter case, the multiple data packets may be sent back across the distributed interconnect in an order specified by element ordering information included in the RMA protocol request message (or included in a combination of multiple RMA protocol request messages), or otherwise may be sent so that the requested multiple data elements are received by application processing engine 1070 in the order specified by the element ordering information included in the RMA protocol request message/s.

When the combined data packet (or multiple data packets) arrives at application processing engine 1070, AOS fabric RMA engine 5030 recognizes the data class of the distributed RMA protocol response message, and then uses the distributed RMA protocol header extension array to step through and deliver each element of requested data directly to the particular AOS buffer/s (e.g., physical address) specified for that data element in the returned distributed RMA protocol header extension array. AOS fabric RMA engine 5030 may step through and deliver each element of requested data in specified order when that element ordering information is included in the original distributed RMA protocol request message. Alternatively, element ordering may be implied to a fabric RMA engine receiving the data by the ordering of the physical address/extent elements in the distributed RMA array.

In a further embodiment, controlled access to the memory of a first processing object may be provided to a second processing object by using virtual tags or other virtual identifiers that represent a particular location in the memory of the first processing object, but that do not contain the complete literal memory address of the first processing object. In this regard, virtual tags may be implemented using any suitable methodology for hiding, disguising or otherwise keeping confidential the literal memory address of the first processing object/s, while at the same time providing remote memory access in a manner as described elsewhere herein.

In one exemplary embodiment, a virtual tag may be formulated by a first processing object using address translation techniques. For example, a virtual tag communicated by a first processing object to a second processing object may represent only a selected portion of the targeted literal memory address of the first processing object. Upon receipt of response information containing the virtual tag, the first processing object may construct the literal memory address (e.g., by adding a base register to the virtual tag to construct the complete literal address) so that the information may be then placed into the targeted memory location.

In another exemplary embodiment, a first processing object may construct a virtual tag by encrypting or encoding the targeted literal memory address prior to communicating it to the second processing object. The first processing object may then de-encrypt or de-code the virtual tag to obtain the literal memory address upon receipt of the response information containing the virtual tag from the second processing engine.

In yet another exemplary embodiment, a first processing object may generate an address key to accompany a literal address tag communicated to a second processing object (e.g., placed in an additional header field of a request message). Such a key may be generated using any suitable method, for example, using an algorithm, using a hardcoded value resident in the hardware of the processing object, a combination thereof, etc. Only response information from the second processing object that contains the address key will be placed into the targeted memory location using the remote memory access methodology described herein.

Controlled remote memory access may be advantageously used to provide the advantages of remote access to the memory of the first processing object/s for placement of requested or otherwise desired information, while at the same time providing security to help prevent placement of undesired information and to prevent undesired memory alteration (e.g., to prevent accidental or intentional damage or other undesirable access to the memory of the first processing object/s by other processing objects). This feature may be desirable, for example, in multi-vendor or uncontrolled distributed processing/distributed memory environments.

### EXAMPLES

The following examples are illustrative and should not be construed as limiting the scope of the invention or claims thereof.

In the following hypothetical examples of Comparative Example A and Example 1, a hypothetical workload is assumed that is an AOS running on an Intel Pentium III class computer at 733 Megahertz, receiving messages from a SOS over a switch fabric at a rate of 32 Megabytes per second (8,192 4-Kilobyte pages per second).

### Comparative Example A

Assuming no provision for remote memory access from the SOS to the AOS memory, an additional buffer copy is required for every message received from the SOS when the AOS initiates a read I/O. Each message is initially transferred from a source buffer in the SOS across the switch fabric into a reserved receive buffer in the AOS fabric dispatcher. Block copies of non-cached data in 4 Kilobyte (4K) chunks are assumed. It is assumed that the source buffer for the copy is “new” data that was not in cache initially (i.e., it is assumed that the AOS would not have initiated read I/O on the data had the data been in cache). After the block copy is created in the receive buffer, a receive agent then determines the intended recipient and copies the message into the recipient's buffer.

In this example, it is estimated that non-cached block copies of 4K pages will take somewhere between 3.6 and 5.6 clock cycles per byte (read from source plus write to destination), depending on the AOS and the specific instruction family used in the copy code. Given an assumed workload of 32 Megabytes per second and a clock cycle estimate of 3.6 to 5.6 cycles per byte, this workload will consume between 117,964,800 and 183,500,800 clocks per second, or between 16 and 25 percent of a 733 MHz Pentium III's cycles.

### Example 1

In this hypothetical example, it as assumed that the DRP embodiment described and illustrated herein in relation to FIG. 6A is mplemented with the system and workload conditions of Comparative Example A. In such an implementation, it is estimated that by eliminating buffer copies in the read I/O path, implementation of DRP allows 16 to 25 percent of the CPU cycles required by the AOS to be freed up for other purposes.

### Example 2

In this example, distributed RMA protocol messaging is described in relation to the exemplary distributed RMA protocol response message PDU header 2000 illustrated and described herein in relation to FIG. 5. In this exemplary embodiment, two processing entities 6070 and 6040 are in communication across a distributed interconnect, in this case switch fabric 6080 as illustrated in FIG. 7. Two processing objects, 6010 and 6050 are illustrated running on respective processing entities 6070 and 6040. In this exemplary embodiment, processing objects 6010 and 6050 communicate utilizing messages to satisfy data operations between the two objects. In FIG. 7, logical message flow between processing objects 6010 and 6050 is illustrated by dashed lines, representing communication between processing objects 6010 and 6050 that is not aware of switch fabric 6080. Inter-processing entity message flow across switch fabric 6080 is illustrated by solid lines in the same figure.

In this example, processing objects 6010 and 6050 may use Message Class 17 (0x11) to communicate with each other across fabric switch 6080 via respective Fabric Driver (“FabDriver”) interfaces 6025 and 6065, that may each include fabric RMA engines and fabric dispatcher components as described elsewhere herein. In their predefined Message scheme within Message Class 17 (Magic Example Msg Protocol <MEMP>), Message ID 4 (MEMP:Gimme Some Data Msg type) is specified as a data request that uses distributed RMA protocol response messages to transfer the requested data, where “MEMP” represents any pertinent message class value. In this example, the Message Class definition is arbitrarily defined for example purposes only, and Message Class 17 may have several other Message ID values for other functions employed between processing objects 6010 and 6050.

In this example, processing object 6050 may encounter an event that requires data from processing object 6010, in this case requiring that the data be placed in a specific area of memory. Accordingly, processing object 6050 issues a request (e.g., a distributed RMA protocol PDU request message) having the following parameters:

Message Class=17 (MEMP)

Message ID=4 (Gimme Some Data)

Option Flags=0x18 (TARGET_CONTEXT_TAGGED SOURCE_CONTEXT_TAGGED)

PDU Header Size=20 (this sets the Cell Flags to 0x02 in the FabDriver; this is an imaginary parameter passed to the FabDriver Xmit API for this example)

Target Context ID=0x03208AC4 (target physical memory address where processing object 6050 wants the response data placed in RAM memory of processing entity 6040).

Source Context ID=0x18A02344 (linear address of buffer header; processing object 6050 uses this to manage the target buffer—may be, for example, any relevant value to the requester)

FabDriver 6065 takes these parameters, builds the PDU header with the other necessary values (Src ID, Sequence Number, etc.), and transmits this PDU to processing entity 6070 via a transmit queue 2. FabDriver 6025 on processing entity 6070 receives the PDU with the Message Class 17:Message ID 4 values and passes the received PDU to processing object 6010. Processing object 6010 decodes the message and acquires the data that processing object 6050 has requested. Processing object 6010 is configured in this embodiment to understands that all Message ID 4 (Gimme Some Data) PDUs require the response data to be sent back to the requesting processing object via distributed RMA protocol messages. Processing object 6010 then proceeds to build the response distributed RMA protocol message to send to processing object 6050. The distributed RMA response message may have the following parameters:

Message Class=10 (distributed RMA protocol Message class)

Message ID=17 (MEMP; used to indicate the requester's original message class)

Option Flags=0x1A (RESPONSE|TARGET_CONTEXT_TAGGED|SOURCE_CONTEXT_TAGGED)

PDU Header Size=20 (this sets the Cell Flags to 0x02 in the FabDriver; this is an imaginary parameter passed to the FabDriver Xmit API for this example)

Target Context ID=0x03208AC4 (target physical memory address where processing object 6050 wants the response data placed into RAM memory of processing entity 6050).

Source Context ID=0x18A02344 (linear address of buffer header; processing object 6050 uses this to manage the target buffer—may be, for example, any relevant value to the requester)

FabDriver 6025 builds the PDU header for the distributed RMA protocol response message from processing object 6010 and sends it to processing entity 6040. Fabric RMA engine of FabDriver 6065 receives the distribute RMA response message and finds the appropriate buffer descriptor chain for receipt completion (Rx) notification. The Fabric RMA engine of FabDriver 6065 places the PDU header in the next available Buffer Descriptor PDU Header field, and then places the data payload of the distributed RMA protocol response into RAM memory of processing entity 6040 using the Target Context ID field's value which contained original target physical memory buffer address of processing object 6050.

After placing the data payload into memory of processing entity 6040, the Fabric RMA engine of FabDriver 6065 sets the completion notification in the Buffer Descriptor Flags field (0x0000) and generates a receive (Rx) interrupt if one is enabled. Upon receipt of the distributed RMA protocol Rx completion indication, FabDriver 6065 signals processing object 6050 that an incoming distributed RMA protocol response message has been received/completed. If FabDriver 6065 has more than one processing object operation that is soliciting incoming distributed RMA protocol operations, it may use the distributed RMA protocol response message Message ID field (which contains the original requester's Message Class value) to determine what processing object operation needs to be signaled.

It will be understood with benefit of this disclosure that although specific exemplary embodiments of hardware and software have been described herein, other combinations of hardware and/or software may be employed to achieve one or more features of the disclosed systems and methods. Furthermore, it will be understood that operating environment and application code may be modified as necessary to implement one or more aspects of the disclosed technology, and that the disclosed systems and methods may be implemented using other hardware models as well as in environments where the application and operating system code may be controlled.

Thus, while the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus, systems and methods may be utilized in various combinations and/or independently. Thus the invention is not limited to only those combinations shown herein, but rather may include other combinations.

### REFERENCES

The following references, to the extent that they provide exemplary system, apparatus, method, or other details supplementary to those set forth herein, are specifically incorporated herein by reference.

U.S. Patent Application Serial Number 10/003,683 filed on Nov. 2, 2001 which is entitled “SYSTEMS AND METHODS FOR USING DISTRIBUTED INTERCONNECTS IN INFORMATION MANAGEMENT ENVIRONMENTS”

U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS”

U.S. patent application Ser. No. 09/797,413 filed on Mar. 1, 2001 which is entitled “NETWORK CONNECTED COMPUTING SYSTEM”

U.S. Provisional Patent Application Serial No. 60/285,211 filed on Apr. 20, 2001 which is entitled “SYSTEMS AND METHODS FOR PROVIDING DIFFERENTIATED SERVICE IN A NETWORK ENVIRONMENT”

U.S. Provisional Patent Application Serial No. 60/291,073 filed on May 15, 2001 which is entitled “SYSTEMS AND METHODS FOR PROVIDING DIFFERENTIATED SERVICE IN A NETWORK ENVIRONMENT”

U.S. Provisional Patent Application Serial No. 60/246,401 filed on Nov. 7, 2000 which is entitled “SYSTEM AND METHOD FOR THE DETERMINISTIC DELIVERY OF DATA AND SERVICES”

U.S. patent application Ser. No. 09/797,200 filed on Mar. 1, 2001 which is entitled “SYSTEMS AND METHODS FOR THE DETERMINISTIC MANAGEMENT OF INFORMATION”

U.S. Provisional Patent Application Serial No. 60/187,211 filed on Mar. 3, 2000 which is entitled “SYSTEM AND APPARATUS FOR INCREASING FILE SERVER BANDWIDTH”

U.S. patent application Ser. No. 09/797,404 filed on Mar. 1, 2001 which is entitled “INTERPROCESS COMMUNICATIONS WITHIN A NETWORK NODE USING SWITCH FABRIC”

U.S. patent application Ser. No. 09/947,869 filed on Sep. 6, 2001 which is entitled “SYSTEMS AND METHODS FOR RESOURCE MANAGEMENT IN INFORMATION STORAGE ENVIRONMENTS”

U.S. patent application Ser. No. 10/003,728 filed on Nov. 2, 2001, which is entitled “SYSTEMS AND METHODS FOR INTELLIGENT INFORMATION RETRIEVAL AND DELIVERY IN AN INFORMATION MANAGEMENT ENVIRONMENT”

U.S. Provisional Patent Application Serial No. 60/246,343, which was filed Nov. 7, 2000 and is entitled “NETWORK CONTENT DELIVERY SYSTEM WITH PEER TO PEER PROCESSING COMPONENTS”

U.S. Provisional Patent Application Serial No. 60/246,335, which was filed Nov. 7, 2000 and is entitled “NETWORK SECURITY ACCELERATOR”

U.S. Provisional Patent Application Serial No. 60/246,443, which was filed Nov. 7, 2000 and is entitled “METHODS AND SYSTEMS FOR THE ORDER SERIALIZATION OF INFORMATION IN A NETWORK PROCESSING ENVIRONMENT”

U.S. Provisional Patent Application Serial No. 60/246,373, which was filed Nov. 7, 2000 and is entitled “INTERPROCESS COMMUNICATIONS WITHIN A NETWORK NODE USING SWITCH FABRIC”

U.S. Provisional Patent Application Serial No. 60/246,444, which was filed Nov. 7, 2000 and is entitled “NETWORK TRANSPORT ACCELERATOR”

U.S. Provisional Patent Application Serial No. 60/246,372, which was filed Nov. 7, 2000 and is entitled “SINGLE CHASSIS NETWORK ENDPOINT SYSTEM WITH NETWORK PROCESSOR FOR LOAD BALANCING”

U.S. patent application Ser. No. 09/797,198 filed on Mar. 1, 2001 which is entitled “SYSTEMS AND METHODS FOR MANAGEMENT OF MEMORY”

U.S. patent application Ser. No. 09/797,201 filed on Mar. 1, 2001 which is entitled “SYSTEMS AND METHODS FOR MANAGEMENT OF MEMORY IN INFORMATION DELIVERY ENVIRONMENTS”

U.S. Provisional Application Serial No. 60/246,445 filed on Nov. 7, 2000 which is entitled “SYSTEMS AND METHODS FOR PROVIDING EFFICIENT USE OF MEMORY FOR NETWORK SYSTEMS”

U.S. Provisional Application Serial No. 60/246,359 filed on Nov. 7, 2000 which is entitled “CACHING ALGORITHM FOR MULTIMEDIA SERVERS”

U.S. Provisional Patent Application Serial No. 60/353,104, filed Jan. 30, 2002, and entitled “SYSTEMS AND METHODS FOR MANAGING RESOURCE UTILIZATION IN INFORMATION MANAGEMENT ENVIRONMENTS,” by Richter et. al.

U.S. Provisional Patent Application Serial No. 60/353,561, filed Jan. 31, 2002, and entitled “METHOD AND SYSTEM HAVING CHECKSUM GENERATION USING A DATA MOVEMENT ENGINE,” by Richter et al.

U.S. Provisional Patent Application Serial No. 60/353,641, filed Jan. 31, 2002, and entitled “SYSTEM AND METHODS FOR READ/WRITE I/O OPTIMIZATION IN INFORMATION MANAGEMENT ENVIRONMENTS,” by Richter et al.

U.S. patent application Ser. No. 10/060,940, filed Jan. 30, 2002, and entitled “SYSTEMS AND METHODS FOR RESOURCE UTILIZATION ANALYSIS IN INFORMATION MANAGEMENT ENVIRONMENTS,” by Jackson et al.

What is claimed is:

1. A method of exchanging information between a first processing object and a second processing object, comprising:
labeling a first information with a first identifier;
communicating said first information from said first processing object to said second processing object;
labeling a second information with a second identifier, said second identifier being based at least in part on said first identifier;
communicating said second information from said second processing object to said first processing object; and
accessing a particular location in a memory associated with said first processing object based at least in part on said second identifier.

2. The method of claim 1, wherein said steps of labeling, communicating and accessing are performed on a transactional basis.

3. The method of claim 2, wherein said accessing comprises placing at least a portion of said second information into a particular location in said memory associated with said first processing object based at least in part on said second identifier.

4. The method of claim 1, wherein said first identifier comprises one or more tags representing a list of multiple particular locations in said memory associated with said first processing object; and wherein said method further comprises accessing at least one of said particular locations in said memory associated with said first processing object based at least in part on said second identifier.

5. The method of claim 4, wherein said method further comprises controlling flow of said second information communicated from said second processing object to said first processing object by controlling communication of said first information from said first processing object to said second processing object.

6. The method of claim 1, wherein at least one of said communicating steps is performed in an asynchronous manner.

7. The method of claim 3, wherein said first information and said second information comprise distributed RMA protocol messages.

8. The method of claim 3, wherein said first and second identifiers each represent said particular location in said memory associated with said first processing object.

9. The method of claim 8, wherein said first identifier and said second identifier are the same.

10. The method of claim 8, wherein said first processing object comprises an application operating system, and wherein said second processing object comprises a storage operating system.

11. The method of claim 9, wherein each of said first and second identifiers comprise at least part of a distributed RMA protocol message communicated between said first processing object and said second processing object.

12. The method of claim 10, wherein said first information comprises a request for information; and wherein said second information comprises a response that includes said requested information.

13. The method of claim 12, wherein said application operating system is resident on an application processing engine and wherein said storage operating system is resident on a storage processing engine; wherein said application processing engine and said storage processing engine are coupled together to comprise part of a content delivery system; wherein said request for information comprises a request for content; and wherein said response includes said requested content.

14. The method of claim 13, wherein said content delivery system comprises multiple processing engines coupled together, said multiple processing engines comprising multiple application processing engines, multiple storage processing engines, or a combination thereof and wherein said method further comprises communicating requests for information from operating systems of two or more of said multiple application processing engines to an operating system of one of said storage processing engines, communicating responses from operating systems of two or more of said storage processing engines to an application operating system of one of said application processing engines, or a combination thereof.

15. The method of claim 3, wherein no buffer copies of said at least a portion of said second information are utilized when communicating said second information from said second processing object to said first processing object, and when placing said at least a portion of said second information into said particular location in said memory associated with said first processing object.

16. The method of claim 1, wherein said first and second processing objects are communicatively coupled together in a distributed processing environment; and wherein said memory associated with said first processing object comprises at least a portion of distributed memory within said distributed processing environment.

17. The method of claim 1, wherein said first identifier comprises a virtual identifier; and wherein said method further comprises using said virtual identifier to control access to said memory associated with said first processing object.

18. The method of claim 1, wherein said first identifier comprises a RMA tag that includes information identifying said particular location in said memory associated with said first processing object.

19. A method of exchanging information between first and second processing entities that are communicatively coupled together, said method comprising:
communicating a first information from a first processing entity to a second processing entity, said first information being labeled with a first identifier representing a particular location in the memory of said first processing entity;
communicating a second information from said second processing entity to said first processing entity, said second information being labeled with a second identifier based at least in part on said first identifier with which said first information was labeled; and
accessing a particular location in a memory associated with said first processing entity based at least in part on said second identifier.

20. The method of claim 19, wherein said steps of communicating and accessing are performed on a transactional basis.

21. The method of claim 20, wherein said accessing comprises placing at least a portion of said second information into a particular location in said memory associated with said first processing entity based at least in part on said second identifier.

22. The method of claim 19, wherein said first identifier comprises one or more tags representing a list of multiple particular locations in said memory of said first processing entity; and wherein said method further comprises accessing at least one of said particular locations in said memory associated with said first processing entity based at least in part on said second identifier.

23. The method of claim 22, wherein said method further comprises controlling flow of said second information communicated from said second processing entity to said first processing entity by controlling communication of said first information from said first processing entity to said second processing entity.

24. The method of claim 19, wherein at least one of said communicating steps is performed in an asynchronous manner.

25. The method of claim 21, wherein said first and second processing entities are coupled together in a distributed processing environment having memory distributed therein; and wherein said memory associated with said first processing entity comprises at least a portion of said memory distributed within said distributed processing environment.

26. The method of claim 21, wherein said first and second processing engines are coupled together with a distributed interconnect.

27. The method of claim 26, wherein said distributed interconnect comprises a switch fabric.

28. The method of claim 26, wherein said distributed interconnect comprises a virtual distributed interconnect.

29. The method of claim 21, wherein said first information comprises a request for information; and wherein said second information comprises a response that includes said requested information.

30. The method of claim 19, wherein said first identifier comprises a virtual identifier; and wherein said method further comprises using said virtual identifier to control access to said memory associated with said first processing entity.

31. The method of claim 19, wherein said first identifier comprises a RMA tag that includes information identifying said particular location in said memory associated with said first processing entity; and wherein said method further comprises communicating said first information from said first processing entity to said second processing entity as a distributed RMA protocol request, and communicating said second information from said second processing entity to said first processing entity as a distributed RMA protocol response to said distributed RMA protocol request.

32. A method of exchanging information between first and second processing engines of an information management system that includes a plurality of individual processing engines coupled together by a distributed interconnect, said method comprising:
communicating distributed RMA protocol requests for information across said distributed interconnect from a first processing engine to a second processing engine, each of said distributed RMA protocol requests for information being labeled with a respective identifier representing a particular location in the memory of said first processing engine;
responding to each of said distributed RMA protocol requests for information by communicating a respective distributed RMA protocol response to said distributed RMA protocol request for information across said distributed interconnect from said second processing engine to said first processing engine, each of said distributed RMA protocol responses including information requested by a respective distributed RMA protocol request for information and being labeled with the identifier with which said respective distributed RMA protocol request for information was labeled; and
placing said requested information included with each respective distributed RMA protocol response into a particular location in the memory of said first processing engine represented by the identifier with which said respective distributed RMA protocol response was labeled.

33. The method of claim 32, wherein said distributed interconnect comprises a switch fabric.

34. The method of claim 32, wherein said distributed interconnect comprises a virtual distributed interconnect.

35. The method of claim 32, wherein said information management system comprises a network connectable content delivery system; wherein said first processing engine comprises an application processing engine; wherein said second processing engine comprises a storage processing engine; wherein each of said distributed RMA protocol requests for information comprises a distributed RMA protocol request for content; and wherein said each of said distributed RMA protocol responses include content requested by a respective distributed RMA protocol request for information.

36. The method of claim 35, wherein said distributed interconnect comprises a switch fabric.

37. The method of claim 36, wherein each of said distributed RMA protocol requests for content and wherein each of said distributed RMA protocol responses to said requests for content each comprise a distributed RMA protocol message that includes a respective identifier associated with said distributed RMA protocol request or labeled response.

38. The method of claim 37, wherein each of said respective identifiers comprise at least part of a distributed RMA protocol header extension that includes information identifying a memory address of an application operating system running on said application processing engine, said memory address being designated for receiving requested content from said storage processing engine that is associated with said respective distributed RMA protocol request or labeled response.

39. The method of claim 36, wherein said content delivery system comprises multiple processing engines coupled together by said distributed interconnect, said multiple processing engines comprising multiple application processing engines, and wherein said method further comprises communicating distributed RMA protocol requests for information from two or more of said multiple application processing engines to one of said storage processing engines, communicating distributed RMA protocol responses from two or more of said storage processing engines to one of said application processing engines, or a combination thereof.

40. The method of claim 32, wherein said method further comprises:
communicating additional non-distributed RMA protocol requests for information across said distributed interconnect from a first processing engine to said second processing engine, each of said non-distributed RMA protocol requests for information not being labeled with a respective identifier representing a particular location in the memory of said first processing engine;
responding to each of said non-distributed RMA protocol requests for information by communicating a respective non-distributed RMA protocol response to said non-distributed RMA protocol request for information across said distributed interconnect from said second processing engine to said first processing engine, each of said non-distributed RMA protocol responses including information requested by a respective non-distributed RMA protocol request for information; and
placing said requested information included with each respective non-distributed RMA protocol response into an arbitrary location in the memory of said first processing engine.

41. The method of claim 40, further comprising:
multiplexing said distributed RMA protocol requests and non-distributed RMA protocol requests and communicating said multiplexed requests from said first processing engine to said second processing engine across said distributed interconnect;
multiplexing said distributed RMA protocol responses and non-distributed RMA protocol responses and communicating said multiplexed responses from said second processing engine to said first processing engine across said distributed interconnect; and
de-multiplexing said distributed RMA protocol responses from said non-distributed RMA protocol responses after communicating said multiplexed responses from said second processing engine to said first processing engine.

42. The method of claim 41, further comprising assigning a message class to each of said distributed RMA protocol requests and said non-distributed RMA protocol requests, said message class being reflective of whether or not the requested information is to be handled using distributed RMA protocol.

43. The method of claim 42, wherein said de-multiplexing comprises separating said distributed RMA protocol requests and said non-distributed RMA protocol requests based on said message class.

44. The method of claim 32, further comprising at least one of:
prioritizing said response to each of said distributed RMA protocol requests relative to said response to other said distributed RMA protocol requests;
prioritizing said placement into memory of requested information included with each of said respective distributed RMA protocol responses relative to said placement into memory of requested information included with other of said respective distributed RMA protocol responses; or
a combination thereof.

45. The method of claim 40, further comprising implementing differentiated service in said information management system by selectively communicating a portion of requests for information across said distributed interconnect as said distributed RMA protocol requests for information and selectively communicating another portion of requests for information across said distributed interconnect as non-distributed RMA protocol requests for information.

46. The method of claim 44, further comprising implementing differentiated service in said information management system by at least one of said prioritizing of said responses to distributed RMA protocol requests; said prioritizing of said placement into memory of requested information included with each of said respective distributed RMA protocol responses; or a combination thereof.

47. The method of claim 32, further comprising:
communicating at least one distributed RMA protocol request across said distributed interconnect from said first processing engine to said second processing engine, said at least one distributed RMA protocol request comprising a single request for multiple elements of data and being labeled with at least one identifier representing a particular location in the memory of said first processing engine for placement of each of said elements of requested data;
responding to said at least one distributed RMA protocol request for multiple elements of data by communicating a single distributed RMA protocol response across said distributed interconnect from said second processing engine to said first processing engine, said single distributed RMA protocol response comprising said requested multiple elements of data and being labeled with said one or more identifiers with which said single distributed RMA protocol request for multiple elements of data was labeled; and
placing each of said requested multiple elements of data included in said distributed RMA protocol response into a particular location in the memory of said first processing engine represented by said at least one identifier with which said respective single distributed RMA protocol response was labeled.

48. The method of claim 32, further comprising:
communicating at least one distributed RMA protocol request across said distributed interconnect from said first processing engine to said second processing engine, said at least one distributed RMA protocol request comprising a single request for multiple elements of data and being labeled with at least one identifier representing a particular location in the memory of said first processing engine for placement of each of said elements of requested data;
responding to said at least one distributed RMA protocol request for multiple elements of data by communicating multiple distributed RMA protocol responses across said distributed interconnect from said second processing engine to said first processing engine, said multiple distributed RMA protocol responses comprising said requested multiple elements of data and being labeled with said one or more identifiers with which said single distributed RMA protocol request for multiple elements of data was labeled; and
placing each of said requested multiple elements of data included in said distributed RMA protocol responses into a particular location in the memory of said first processing engine represented by said at least one identifier with which said multiple distributed RMA protocol responses were labeled.

49. The method of claim 47, wherein said placing of each element of said multiple elements of data is performed in an order specified by element ordering information included in said single distributed RMA protocol response.

50. The method of claim 49, further comprising including said element ordering information in said at least one distributed RMA protocol request for multiple elements of data; and returning said element ordering information in said single distributed RMA protocol response.

51. The method of claim 48, wherein each of said multiple distributed RMA protocol responses comprises a respective one of said requested multiple elements of data; and wherein said method further comprises communicating said multiple distributed RMA protocol responses across said distributed interconnect from said second processing engine to said first processing engine in an order specified by element ordering information included in said single request for said multiple elements of data, and placing said requested multiple elements of data into said memory of said first processing engine in said order that said multiple distributed RMA protocol responses are communicated across said distributed interconnect from said second processing engine to said first processing engine.

52. The method of claim 49, further comprising including said element ordering information in said at least one distributed RMA protocol request for multiple elements of data; and returning said element ordering information in said single distributed RMA protocol response.

53. The method of claim 32, wherein said respective identifier representing a particular location in the memory of said first processing engine comprises a respective virtual identifier; and wherein said method further comprises using said respective virtual identifier to control access to said memory of said first processing engine.

54. The method of claim 32, wherein said respective identifier representing a particular location in the memory of said first processing engine comprises a RMA tag that includes information identifying said particular location in the memory of said first processing engine.

55. A system for exchanging information between a first processing entity and a second processing entity, comprising:
a first processing entity configured to generate a first information, to label said first information with a first identifier, and to communicate said first information to said second processing entity;
a second processing entity configured to generate a second information, to label said second information with a second identifier based at least in part on said first identifier, and to communicate said second information to said first processing entity; and
wherein said first processing entity is further configured to access a particular location in a memory associated with said first processing entity based at least in part on said second identifier.

56. The system of claim 55, wherein said system is configured to exchange said information on a transactional basis.

57. The system of claim 55, wherein said first identifier comprises one or more tags representing a list of multiple particular locations in said memory of said first processing entity; and wherein said first processing entity is configured to access at least one of said particular locations in said memory associated with said first processing entity based at least in part on said second identifier.

58. The system of claim 57, wherein said system is configured to control flow of said second information communicated from said second processing entity to said first processing entity by controlling communication of said first information from said first processing entity to said second processing entity.

59. The system of claim 55, wherein said system is configured to communicate at least one of said first information or said second information in an asynchronous manner.

60. The system of claim 56, wherein said first processing entity is further configured to access said particular location in said memory associated with said first processing entity by placing at least a portion of said second information into a particular location in said memory associated with said first processing entity based at least in part on said second identifier.

61. The system of claim 60, wherein said first information and said second information comprise distributed RMA protocol messages, and wherein said first and second identifiers each represent said particular location in the memory associated with said first processing entity.

62. The system of claim 61, wherein said first identifier and said second identifier are the same, and wherein each of said first and second identifiers comprise at least part of a distributed RMA protocol message communicated between said first processing entity and said second processing entity.

63. The system of claim 61, wherein said first processing entity comprises an application processing engine, wherein said second processing entity comprises a storage processing engine; wherein said first information comprises a request for information; and wherein said second information comprises a response that includes said requested information.

64. The system of claim 63, wherein said application processing engine and said storage processing engine comprise part of a content delivery system; wherein said request for information comprises a request for content; and wherein said response includes said requested content.

65. The system of claim 64, wherein said content delivery system comprises multiple processing engines coupled together by a distributed interconnect, said multiple processing engines comprising multiple application processing engines, multiple storage processing engines, or a combination thereof.

66. The system of claim 55, wherein no buffer copies of said at least a portion of said second information are utilized when communicating said second information from said second processing entity to said first processing entity, and when placing said at least a portion of said second information into said particular location in said memory associated with said first processing entity.

67. The system of claim 65, wherein said distributed interconnect comprises a switch fabric.

68. The system of claim 65, wherein said distributed interconnect comprises a virtual distributed interconnect.

69. The system of claim 55, wherein said first and second processing entities are coupled together in a distributed processing environment; and wherein said memory associated with said first processing entity comprises a distributed memory within said distributed processing environment.

70. The system of claim 55, wherein said first processing entity is configured to label said first information with a first identifier that comprises a virtual identifier.

71. A system for exchanging information between first and second processing engines of an information management system that includes a plurality of individual processing engines coupled together by a distributed interconnect, said system comprising:
a first processing engine configured to communicate first distributed RMA protocol messages across said distributed interconnect to a second processing engine, each of said distributed RMA protocol messages being labeled with one or more respective identifiers representing one or more particular locations in the memory of said first processing engine;
a second processing engine configured to communicate second distributed RMA protocol messages across said distributed interconnect to said first processing engine, said second distributed RMA protocol messages including information labeled with one or more identifiers with which at least one or said first distributed RMA protocol messages was labeled; and
wherein said first processing engine is further configured to place said information included with said second distributed RMA protocol messages into particular locations in the memory of said first processing engine represented by said one or more identifiers with which said second distributed RMA protocol messages are labeled.

72. The system of claim 71, wherein said first distributed RMA protocol messages comprise distributed RMA protocol requests; and wherein said second distributed RMA protocol messages comprise respective distributed RMA protocol responses to said distributed RMA protocol requests for information.

73. The system of claim 72, wherein said distributed interconnect comprises a virtual distributed interconnect.

74. The system of claim 72, wherein said information management system comprises a network connectable content delivery system; wherein said distributed interconnect comprises a switch fabric; wherein said first processing engine comprises an application processing engine; wherein said second processing engine comprises a storage processing engine; wherein each of said distributed RMA protocol requests for information comprises a distributed RMA protocol request for content; and wherein said each of said distributed RMA protocol responses include content requested by a respective distributed RMA protocol request for information.

75. The system of claim 74, wherein each of said distributed RMA protocol requests for content and wherein each of said distributed RMA protocol responses to said requests for content each comprise a distributed RMA protocol message that includes a respective identifier associated with said distributed RMA protocol request or labeled response.

76. The system of claim 75, wherein each of said respective identifiers comprise at least part of a distributed RMA protocol header extension that includes information identifying a memory address of an application operating system running on said application processing engine, said memory address being designated for receiving requested content from said storage processing engine that is associated with said respective distributed RMA protocol request or labeled response.

77. The system of claim 74, wherein said system further comprises multiple processing engines coupled together by said distributed interconnect, said multiple processing engines comprising multiple application processing engines, and wherein two or more of said processing engines are configured to communicate distributed RMA protocol requests for information to one of said storage processing engines, wherein two or more of said storage processing engines are configured to communicate distributed RMA protocol responses to one of said application processing engines, or a combination thereof.

78. The system of claim 72, wherein:
said first processing engine is further configured to communicate additional non-distributed RMA protocol requests for information across said distributed interconnect to said second processing engine, each of said non-distributed RMA protocol requests for information not being labeled with a respective identifier representing a particular location in the memory of said first processing engine;
said second processing engine is further configured to respond to each of said non-distributed RMA protocol requests for information by communicating a respective non-distributed RMA protocol response to said non-distributed RMA protocol request for information across said distributed interconnect to said first processing engine, each of said non-distributed RMA protocol responses including information requested by a respective non-distributed RMA protocol request for information; and
wherein said first processing engine is further configured to place said requested information included with each respective non-distributed RMA protocol response into an arbitrary location in the memory of said first processing engine.

79. The system of claim 78, wherein:
said first processing engine is further configured to multiplex said distributed RMA protocol requests and non-distributed RMA protocol requests, and
to communicate said multiplexed requests to said second processing engine across said distributed interconnect;
said second processing engine is further configured to multiplex said distributed RMA protocol responses and non-distributed RMA protocol responses, and to communicate said multiplexed responses from said second processing engine to said first processing engine across said distributed interconnect; and
wherein said first processing engine is further configured to de-multiplex said distributed RMA protocol responses from said non-distributed RMA protocol responses.

80. The system of claim 79, wherein said first processing engine is further configured to assign a message class to each of said distributed RMA protocol requests and said non122 distributed RMA protocol requests, said message class being reflective of whether or not the requested information is to be handled using distributed RMA protocol.

81. The system of claim 80, wherein said de-multiplexing comprises separating said distributed RMA protocol requests and said non-distributed RMA protocol requests based on said message class.

82. The system of claim 72, wherein:
said second processing engine is further configured to prioritize said response to each of said distributed RMA protocol requests relative to said response to other said distributed RMA protocol requests;
said first processing engine is further configured to prioritize said placement into memory of requested information included with each of said respective distributed RMA protocol responses relative to said placement into memory of requested information included with other of said respective distributed RMA protocol responses; or
a combination thereof.

83. The system of claim 78, wherein said first processing engine is further configured to implement differentiated service in said information management system by selectively communicating a portion of requests for information across said distributed interconnect as said distributed RMA protocol requests for information and selectively communicating another portion of requests for information across said distributed interconnect as non-distributed RMA protocol requests for information.

84. The system of claim 82, wherein:
said second processing engine is further configured to implement differentiated service in said information management system by said prioritizing said responses to distributed RMA protocol requests;
said first processing engine is further configured to implement differentiated service in said information management system by said prioritizing of said placement into memory of requested information included with each of said respective distributed RMA protocol responses; or
a combination thereof.

85. The system of claim 72, wherein:
said first processing engine is further configured to communicate at least one distributed RMA protocol request across said distributed interconnect to said second processing engine, said at least one distributed RMA protocol request comprising a single request for multiple elements of data and being labeled with at least one identifier representing a particular location in the memory of said first processing engine for placement of each of said elements of requested data;
said second processing engine is further configured to respond to said at least one distributed RMA protocol request for multiple elements of data by communicating multiple distributed RMA protocol responses across said distributed interconnect to said first processing engine, said multiple distributed RMA protocol responses comprising said requested multiple elements of data and being labeled with said one or more identifiers with which said single distributed RMA protocol request for multiple elements of data was labeled; and
wherein said first processing engine is further configured to place each of said requested multiple elements of data included in said multiple distributed RMA protocol responses into a particular location in the memory of said first processing engine represented by said at least one identifier with which said multiple distributed RMA protocol responses were labeled.

86. The system of claim 85, wherein each of said multiple distributed RMA protocol responses comprises a respective one of said requested multiple elements of data; and wherein said second processing engine is further configured to respond to said at least one distributed RMA protocol request for multiple elements of data by communicating said multiple distributed RMA protocol responses across said distributed interconnect from said second processing engine to said first processing engine in an order specified by element ordering information included in said single request for said multiple elements of data; and wherein said first processing engine is further configured to place each of said requested multiple elements of data included in said multiple distributed RMA protocol responses into said memory of said first processing engine in said order that said multiple distributed RMA protocol responses are communicated across said distributed interconnect from said second processing engine to said first processing engine.

87. The system of claim 72, wherein:
said first processing engine is further configured to communicate at least one distributed RMA protocol request across said distributed interconnect to said second processing engine, said at least one distributed RMA protocol request comprising a single request for multiple elements of data and being labeled with at least one identifier representing a particular location in the memory of said first processing engine for placement of each of said elements of requested data;
said second processing engine is further configured to respond to said at least one distributed RMA protocol request for multiple elements of data by communicating a single distributed RMA protocol response across said distributed interconnect to said first processing engine, said single distributed RMA protocol response comprising said requested multiple elements of data and being labeled with said one or more identifiers with which said single distributed RMA protocol request for multiple elements of data was labeled; and
wherein said first processing engine is further configured to place each of said requested multiple elements of data included in said distributed RMA protocol response into a particular location in the memory of said first processing engine represented by said at least one identifier with which said respective single distributed RMA protocol response was labeled.

88. The system of claim 87, wherein said first processing engine is further configured to place each element of said multiple elements of data in an order specified by element ordering information included in said single distributed RMA protocol response.

89. The system of claim 88, wherein said first processing engine is further configured to include said element ordering information in said at least one distributed RMA protocol request for multiple elements of data; and said second processing engine is further configured to return said element ordering information in said single distributed RMA protocol response.

90. The system of claim 71, wherein said one or more respective identifiers representing one or more particular locations in the memory of said first processing engine each comprise virtual identifiers.

91. A network connectable content delivery system, comprising:
an application processing engine, said application processing engine comprising an application operating system, an AOS fabric dispatcher, an application fabric RMA engine, and one or more AOS buffers;
a storage processing engine communicatively coupled to said application processing engine by a distributed interconnect, said storage processing engine comprising a storage operating system, a SOS fabric dispatcher and a storage fabric RMA engine;
wherein said application operating system is in communication with said AOS fabric dispatcher, wherein said AOS fabric dispatcher is in communication with said application fabric RMA engine, and wherein said application fabric RMA engine is in communication with said distributed interconnect; and
wherein said storage operating system is in communication with said SOS fabric dispatcher, wherein said SOS fabric dispatcher is in communication with said storage fabric RMA engine, and wherein said storage fabric RMA engine is in communication with said distributed interconnect.

92. The system of claim 91, wherein said storage processing engine further comprises a SOS file system.

93. The system of claim 91, wherein said distributed interconnect comprises a switch fabric.

94. The system of claim 91, wherein said distributed interconnect comprises a virtual distributed interconnect.

95. The system of claim 93, wherein said AOS fabric dispatcher and said AOS buffers comprise a part of said application operating system, and wherein said SOS fabric dispatcher comprise a part of said storage operating system

96. The system of claim 95, wherein said AOS fabric dispatcher is configured to exchange distributed RMA protocol messages across said distributed interconnect with said SOS fabric dispatcher via said application fabric RMA engine and said storage fabric RMA engine.

97. The system of claim 96, wherein said storage processing engine is coupled to one or more content sources.

98. The system of claim 97, wherein said AOS fabric dispatcher is configured to manage said AOS buffers for placement of requested data retrieved from said content sources that is received across said distributed interconnect from said storage processing engine via said AOS fabric RMA engine; wherein said placement is based at least in part on at least one identifier comprising at least a part of a distributed RMA protocol message received from said SOS fabric dispatcher.

99. The system of claim 98, wherein said storage processing engine further comprises a SOS file system that is configured to enable storage operating system to also retrieve requested data elements as non-contiguous data.

100. The system of claim 91, wherein said content delivery system comprises an endpoint content delivery system.
